(19) United States
(12) Patent Application Publication
(10) Pub. No.: US 2004/0225051 A1
(43) Pub. Date: Nov. 11, 2004

(54) Aqueous multicolor paint with improved solvent resistance

(76) Inventor: Wynn Moy, Tinley Park, IL (US)

Correspondence Address: OLSON & HIERL, LTD., 36th Floor, 20 North Wacker Drive, Chicago, IL, 60606, US

(21) Appl. No.: 10/295,818

(22) Filed: Nov. 15, 2002

(51) Int. Cl. C08K 3/20

(52) U.S. Cl. 524/501

(57) ABSTRACT

A water-in-water multicolor paint composition is provided that is based on carboxylated polymer which is film forming, water-dispersed, and cross-linkable and which is admixed with a film-forming, cross-linkable hydrophobic polyisocyanate. The paint has a disperse phase and a continuous phase. When applied as a coating and dried, the coating displays improved solvent (water and common organic liquids) resistance. Methods for preparing the paint are also provided.

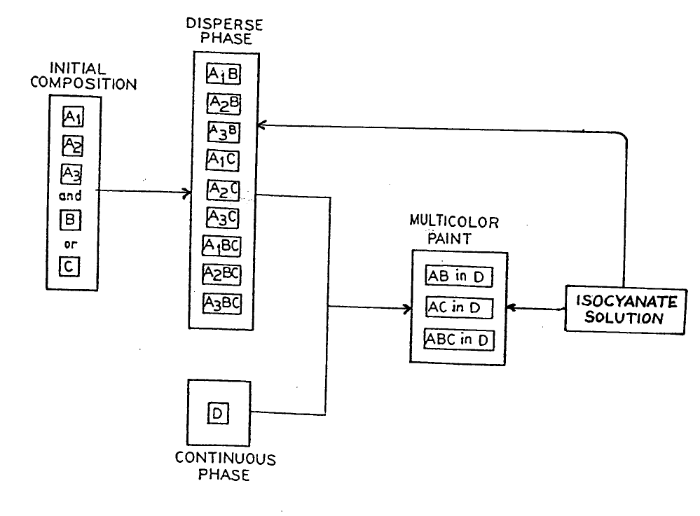

### FIELD OF THE INVENTION

The present invention relates to a water-in-water multicolor paint emulsion having improved solvent resistance that is based on a film-forming, cross-linkable, water-dispersed, polymer system of carboxylated polymer which is in admixture with a film forming, cross-linkable hydrophobic polyisocyanate.

### BACKGROUND OF THE INVENTION

A multicolor paint is a composition that, when coated on a surface and dried, results in a coating that is characterized by dispersed, discrete, visibly discernible spots (or dots).

Water-in-water multicolor paint emulsions based on an inert film-forming, cross-linkable, water-dispersed polymer system of a carboxylated polymer and/or a polyurethane polymer have previously been known as provided by Lynch et al. U.S. Pat. Nos. 5,314,535 and 5,318,619. Water-in-water multicolor paint compositions are increasingly desired in order to limit the quantity of organic volatiles emitted into the environment by a paint during application and subsequent air drying such as would occur with nonaqueous multicolor paint compositions.

Although multicolor paints based on such polymers have enjoyed considerable commercial success, it has been observed that such a paint when coated on a surface and dried can result in a coating that would be benefitted by having improved solvent resistance, that is, resistance to water and to common organic liquids.

Such prior art multicolor paints have usually demonstrated better capacity to coat a metal surface that is preliminarily coated with an applied primer, such as a polyurethane primer, than to coat a bare metal surface. The cost of using a multicolor paint would be benefitted if the multicolor paint could, if desired, be applied, for example, to a bare metal or treated metal surface directly without an intervening preliminarily applied primer coat.

Modified improved multicolor paints based on carboxylated polymer and/or polyurethane polymer have now surprisingly and unexpectedly been achieved which display improved solvent resistance. In addition, multicolor paints based on certain carboxylated polymers have now been achieved that have the capacity to be coated on bare or chemically treated metal surfaces directly without the need for a preliminarily applied primer coat.

### SUMMARY OF THE INVENTION

The present invention provides a class of water-in-water multicolor paints having improved solvent resistance. The paints are based on an inert film-forming, cross-linkable, water-dispersed polymer system of a carboxylated polymer in combination with a minor amount of a hydrophobic polyisocyanate.

The present inventive multicolor paint compositions are achieved by admixing a controlled but minor amount of a hydrophobic polyisocyanate into a water-in-water multicolor paint of the type having a continuous phase and a disperse phase. The disperse phase is comprised of discrete bodies. Each phase incorporates an inert film-forming, water-dispersed, cross-linkable carboxylated polymer system.

As generally taught in the above-cited Lynch et al. patents, the continuous phase and the disperse phase are each prepared and then blended together. The hydrophobic polyisocyanate, preferably preliminarily dissolved in a substantially completely water immiscible organic solvent, is added to and admixed with the continuous and/or the discontinuous phases, or with the multicolor paint comprised of the continuous phase with the discontinuous phase dispersed therein.

A resulting multicolor paint composition of this invention, after being coated and dried upon a substrate, surprisingly and unexpectedly displays improved water and organic chemical solvent resistance compared to a multicolor paint composition containing only carboxylated polymer. The improved solvent resistance of the coating is achieved without loss of excellent surface and wear characteristics. Examples of organic chemical solvents include methyl ethyl ketone, gasohol and hydraulic fluid.

In one preferred class of multicolor paints of this invention, the carboxylated polymer system is copolymer comprised of styrene and acrylic monomer. Product multicolor paint compositions not only demonstrate improved water and organic chemical solvent resistance, but also demonstrate the capacity to be applied as a coating to a clean surface of a metal, such as aluminum or a conventionally chemically pretreated aluminum, directly without the use of a preliminarily applied primer, such as a polyurethane primer. With multicolor paints based on carboxylated polymer that did not contain the hydrophobic polyisocyanate, the use of a primer coating was typically necessary in order to apply the multicolor paint composition to the metal surface and achieve a dried coating with substantial water and organic chemical solvent resistance.

The inventive multicolor paint product compositions of this invention can also incorporate, if desired, a water soluble, film-forming, cross-linkable, pressure-responsive contact adhesive, of the type, for example, taught in the above cited Lynch et al. '619 patent, with the result that the improved solvent resistance of an applied and dried coating is obtained along with improvements in such properties as improved transfer capacity from an applicator, such as a roller or the like, onto a substrate, including higher transfer rates, thicker paint coatings in a shorter time, better early tack, better quick stick and better green strength plus drying to coatings that are smooth, durable and non-tacky.

The inventive multicolor paint compositions have excellent stability characteristics.

The inventive multicolor paint compositions are complex compositions. The particular reason or reasons why the addition of a hydrophobic polyisocyanate to an aqueous multicolor paint composition incorporating a polymer base as taught herein is effective to achieve the above-indicated improved characteristics is presently unknown.

Other and further objects, aims, purposes, features, advantages, applications, embodiments and the like will be apparent to those skilled in the art from the present specification taken with the appended claims.

### BRIEF DESCRIPTION OF THE DRAWING

In the drawing, a flow sheet is shown illustrating blending sequences suitable for use in practicing the present invention.

### DETAILED DESCRIPTION

(a) Definitions

The term “water dispersed” or “water dispersible” as used herein with reference, for example, to a curable carboxylated polymer composition, means that the composition can form a water solution or a colloidal suspension in water. However, to enhance the water dispersability of such a composition, and to increase the amount of the polymer composition which is present per unit of liquid volume in a water dispersed form, particularly in the disperse phase of a multicolor paint of this invention, the water is preferably admixed with a limited amount of water miscible organic liquid or cosolvent, such as hereinafter characterized and illustrated, wherein, for example, the polymer and/or other selected material, is at least as dispersible as in water.

The term “dispersed” (and its equivalent word forms such as “dispersible,” dispersability” and the like) as used herein is intended to be inclusive of both colloidal and macrocolloidal suspensions, solutions, mixtures thereof, and the like. Preferably, a polymer or other material employed in a multicolor paint of this invention is characterized by a capacity to disperse either in water, or in a water-miscible organic solvent (i.e., cosolvent) to an extent which is similar to that of the material dispersability in water alone. When a cosolvent is present in an aqueous medium, the quantity thereof is preferably less than about 8 weight percent based on the total weight of the aqueous carrier liquid (or solvent or dispersing liquid) that is present in a given starting polymer dispersion or solution particularly in order to comply with applicable governmental regulations regarding permissible volatiles.

The term “hydrophobic” as used herein refers to the circumstance that a substance, such as a polyisocyanate, is substantially incapable of dissolving in water.

The term “solvent resistance” as used herein with reference to a coated and dried film produced from a multicolor paint of this invention refers to each of water resistance and organic solvent resistance.

The term “water resistance” as used herein with reference to a coated and dried film or coating produced from a multicolor paint of this invention refers to the test procedure of ASTM D-1308-79 with regard to both covered and open spot tests.

The term “organic solvent resistance” as used herein with reference to the resistance of a coated and dried film or coating produced from a multicolor paint of this invention refers to contact with common organic liquids, including methyl ethyl ketone, gasohol, and hydraulic fluid, as measured by ASTM Test Procedure D1308-67 with regard to both covered and open spot tests.

The term “water miscible” is used herein to indicate that an organic liquid is substantially completely admixible with, and dissolvable in, water in all proportions. Water miscible organic liquids suitable for use in a multicolor paint of this invention include ethylene glycol butyl ether and the like. The term “organic cosolvent” as used herein includes water miscible organic liquids.

The term “water immiscible” is used herein to indicate that an organic liquid is substantially completely not admixible with, or dissolvable in, water in any proportions. Suitable water immiscible organic liquids for use as solvents for hydrophobic polyisocyanates employed in the multicolor paints of this invention include n-butyl acetate and the like.

A present preference is to employ in the practice of the present invention, whether as a water miscible or water immiscible liquid, an organic solvent which has a boiling point that is not above about 250° C. for reasons of expedient solvent evaporation during and after application to an inventive multicolor paint composition as a coating upon a substrate.

The term “cross-linkable,” as used herein with reference to, for example, a water dispersed carboxylated polymer, means that the polymer, after being applied to a surface from an aqueous coating composition and allowed to form a film or coating, cross-links (that is, thermosets or cures) and becomes generally and substantially water insoluble through reaction. The cross-linking occurs preferably during the drying which takes place after an aqueous coating composition of the polymer is applied as a coating to a substrate surface and the aqueous carrier of the coating composition is evaporated. Also, the term cross-linking refers to a cross-linking reaction that preferably occurs at ambient temperatures and pressures, although heat may sometimes be used to accelerate the drying and the cross-linking reaction.

The term “reactive curative” or “cross-linking agent” as used herein refers to any reagent or combination of reagents which will react with a cross-linkable carboxylated polymer. A cross-linked polyurethane product can be produced when both the curative (or cross-liking agent) and the carboxylated polymer are first dispersed together in an aqueous starting dispersion and then are incorporated into a paint composition of this invention which is then coated upon a solid substrate and dried. A reactive curative can sometimes be (that is, function as) a cross-linking agent for a cross-linkable carboxylated polymer, and similarly for a cross-linking agent.

The term “storage stability” as used herein with reference to a multicolor paint of this invention means that the paint passes the test procedure of ASTM D-1849-80 which relates to the package stability of paint stored in a 1 quart or 1 liter container at 125±2° F. (52±1° C.) for 1 month or 2 months, respectively, with regard to consistency and settling.

The term “structural integrity” as used herein in relation to a multicolor paint and the disperse phase bodies therein refers to the ability of the disperse phase bodies therein to remain stable and substantially unchanged when subjected at ambient temperature and pressure to a shear mixing force exerted by a Cowles mixing blade operating at about 450 to about 500 rpm.

The term “paint” is used herein in the broad sense of a coloring and coatable substance for spreading as a coating on a surface.

The term “inert film-forming” as used herein with reference to a given polymer or polymer system, particularly a carboxylated polymer system, or a hydrophobic polyisocyanate, which is employed in a multicolor paint of this invention, indicates that, when the given polymer or polymer system is deposited on a substrate surface and is dried to produce a substantially solvent-free coating, which may or may not be cross-linked, and which is comprised substantially only of the given polymer or polymer system, that coating is substantially inert. The term “inert” as used herein in this context refers to the fact that such coating is a solid, has a substantially non-tacky surface, and is generally substantially insoluble and resistant when transitionally or transitorily contacted with water and common organic solvents such as may be used generally in the paint art.

In contrast, the term “film-forming” as used herein with reference to a given polymer or polymer system, particularly a pressure-responsive (or pressure-sensitive) contact adhesive which is optionally employed in a multicolor paint of this invention indicates that, when the given polymer or polymer system is deposited on a substrate surface and is dried to produce a substantially solvent-free coating which may or may not be cross-linked and which is comprised substantially only of the given polymer or polymer system, that coating is substantially tacky. The term “tacky” as used herein in this context refers to the fact that such coating has a sticky surface to which solid objects contacted thereto adhere.

(b) Starting Materials

(1) Carboxylated Polymer

The term “carboxylated polymer” as used herein refers to a cross-linkable (thermosettable) thermoplastic polymer which is produced by polymerizing, and, if necessary or desirable, carboxylating, vinyl group-containing (H₂C═CHC—) monomers at least some of which already may incorporate carboxylic functional groups (—COO—), to produce a polymer product which has a molecular weight that is low enough to permit the polymer product to be an aqueous latex, water dispersed, or water emulsified, and which contains from about 1 to about 7 weight percent on a 100 weight percent total carboxylated polymer weight basis of pendant carboxylic functional groups which are reactive with a cross-linking agent. The carboxylic functional groups may be present in starting polymerizable monomers or may be introduced after polymerization of such monomers. Such carboxylated polymers are known to the prior art, do not as such constitute part of the present invention, and embodiments are believed to be commercially available.

A present preference is for a carboxylated polymer to be comprised of from about 15 to about 50 weight percent of at least one reacted acrylic monomer with the balance up to 100 weight percent being at least one reacted vinyl group containing monomer.

The term “acrylic monomer” is inclusive of a class of polymerizable monomers whose members each contain the moiety: H₂C═CRCOO— where R is hydrogen or methyl. Examples include acrylic acid, methacrylic acid, and esters of these acids, such as methyl (lower alkyl) acrylates, such as methyl methacrylate, and (lower alkyl) acrylate monomers, such as n-butyl acrylate, and the like.

The term “vinyl group containing monomer” has reference to a polymerizable monomer containing the moiety: H₂C═CHR where R is, for example, a carbon containing radical, such as —CN, -phenyl, -cyclohexene, -cyclohexene monoxide, -n-butyl, -bromine, -chlorine, -flourine, —C═CH, -acetate, -butyrate, -hydroxyl, -carbazole, -cetyl ether, —OCH═CH₂, —CH═CH₂, OC₂H₅, —OCH₃, —OCH₂CH(CH₃)₂, and the like. Thus, examples include acrylonitrile, styrene (presently preferred), butadiene, vinyl acetate, vinyl chloride, vinylidene chloride, and the like.

Presently preferred carboxylated polymers are polymers and copolymers containing acrylic monomers. One presently more preferred class of such carboxylated polymers comprises a polymer containing from about 15 to about 50 weight percent of at least one polymerized acrylic monomer with the balance up to 100 weight percent being at least one vinyl group containing monomer on a total polymer weight basis. One presently most preferred class of carboxylated polymers of this class comprises carboxylated styrene acrylate copolymers that are comprised of about 50 to about 75 weight percent styrene and correspondingly about 25 to 50 weight percent of at least one (lower alkyl) acrylate monomer on a 100 weight percent total carboxylated polymer basis. Examples include carboxylated styrene acrylate copolymers available from Eliokem under the trademark “Pliolite” with associated product designation numbers 7103 and 7104 which are believed to be particularly suitable. These copolymers apparently contain, on a 100 weight percent total polymer weight basis, about 65 weight percent styrene and about 35 weight percent n-butyl acetate, and are carboxylated to an extent sufficient to contain about 3 to about 4 weight percent carboxyl groups per molecule.

Another presently more preferred class of such carboxylated polymers comprises a polymer comprised substantially of at least one polymerized acrylic monomer on a total polymer weight basis. Examples of carboxylated polymers of this class are available from Rohm and Haas under the trademarks “Rhoplex 153 1” and “Rhoplex CS4000.”

Some examples of such preferred carboxylic polymers are shown in Table I below:

TABLE I
CROSS-LINKABLE, WATER BASED, FILM
FORMING CARBOXYLATED POLYMER

| ID | | | |
|---|---|---|---|
| No. | Chemical Name | Trade Name/Trademark | Manufacturer/Source |
| 1 | Carboxylated Styrene | “Pliolite” 7103 & 7104 | Eliokem |
| | Acrylate Copolymer | | |
| 2 | Acrylic Latex | “Aquamac” 450 | Eastman |
| 3 | Acrylic Latex | “Aquamac” 500 | Eastman |
| 4 | Acrylic Latex | “Aquamac” 510 | Eastman |
| 5 | Acrylic Latex | “Hydreau” AR 110 | Eastman |
| 6 | Styrene Acrylic Latex | “Aquamac” 260, 440, 447, | Eastman |
| | | 541, 715, 740 | |
| 7 | Styrene Acrylic Latex | “Hydreau” AR 190 | Eastman |
| 8 | Vinyl Acrylic Latex | “Aquamac” 454, 580, 588 | Eastman |
| 9 | Styrene Acrylic Emulsion | “Arolon” 820-W-49 | Reichhold |
| | | “Arolon” 847-W-42 | |
| | | “Arolon” 860-W-45 | |
| 10 | Acrylic Emulsion | “Synthemul” 40-423 | Reichhold |
| 11 | Acrylic Emulsion | AC548, AC2509, AC2529, | Alberdingk Boley, Inc. |
| | | AC2538, AC2599VP, | |
| | | AS2512VP | |
| 12 | Styrene Acrylic Emulsions | AS2681, AS2685, | Alberdingk Boley, Inc. |
| | | AS2688VP | |
| 13 | Acrylic Latex | “Nacrylic” 2550, 2630, | Nacan-ICI |
| | | 6408 | |
| 14 | Vinyl Acrylic Copolymer | “Resyn” 7448 | Nacan-ICI |
| | Emulsion | | |
| 15 | Acrylic Latex | “Joncryl” 2561, 1520 | Johnson Polymer |
| 16 | Acrylic Emulsion | “Joncryl” 538, 1980, 1972 | Johnson Polymer |

Suitable carboxylated polymers are typically cross-linkable. Cross-linking agents with which carboxylated polymers are cross-linkable to produce water-insoluble products in film form are known to the prior art. Organic cross-linking agents for carboxylated polymers are generally preferred for use in the present invention, and present preferences for the inventive multicolor paint compositions include multifunctional carbodiimides and polyfunctional aziridines. Examples of such carbodiimides include “Ucarlink XL-25SE” from the Dow Chemical Company and examples of such aziridines include “Aziridine CX100” from the Avecia Company. A carboxylated polymer system on a 100 weight percent total weight basis can comprise, for example, from and including 0 up to about 25 weight percent organic cross-linking agent with the balance comprising the carboxylated polymer.

As indicated, a carboxylated polymer is initially water dispersible or soluble (including aqueous colloidal dispersions, emulsions, and latices) for purposes of this invention. The amount of water that is present in a given starting aqueous dispersion of carboxylated polymer is typically in the range of about 30 to about 65 weight percent and is preferably in the range of about 50 to 58 weight percent on a 100 weight percent total starting carboxylated polymer starting dispersion basis. However, larger or smaller amounts of water can be present if desired. A cosolvent (an organic liquid) can be also present and the amount thereof can range from and including 0 up to about 8 weight percent (on the same total basis). Various starting carboxylated polymer dispersions can be employed, if desired.

Typically, though not necessarily, a starting aqueous carboxylated polymer is formulated with an internal stabilization system, as those skilled in the art will appreciate. Such systems are known to the carboxylated polymer art and are not as such a part of the present invention. Since the internal stabilization systems used in starting carboxylated polymer dispersions do not adversely affect the method of preparation, the storage stability, the cross-linkability, or the usability of product water-in-water multicolor paints of this invention, so far as now known, it is usually convenient and is now preferred to consider the internal stabilization system, if present, as part of the starting water-dispersed, film-forming, cross-linkable carboxylated polymer composition for purposes of weight percent calculations and the like in preparing or using a product multicolor paint of this invention.

(2) Hydrophobic Polyisocyanates

In accord with the invention hydrophobic polyisocyanates are included in a product multicolor paint. Suitable hydrophobic polyisocyanates are substantially water insoluble but are soluble in substantially water-immiscible organic solvents.

For use in the practice of this invention, a hydrophobic polyisocyanate is preferably preliminarily dissolved in a substantially water-immiscible liquid. A hydrophobic polyisocyanate can sometimes be purchased as such a solution. An illustrative and presently preferred solvent is n-butyl acetate.

Preferably such a solution contains from about 70 to about 85 weight percent of the hydrophobic polyisocyanate on a 100 weight percent total solution basis although larger or smaller amounts of the hydrophobic polyisocyanate may be present in such a solution, if desired.

Hydrophobic polyisocyanates are substantially water insoluble. They are known to the prior art, do not as such constitute part of the invention, and embodiments are believed to be available commercially. These materials are considered to be essentially prepolymers which undergo further reaction with other materials. The exact structure of these hydrophobic polyisocyanate prepolymers is commonly not disclosed by the manufacturer. However, the isocyanates used in these water insoluble prepolymers are known and are commonly disclosed by the polyisocyanate manufacturers. Because of their light stability, aliphatic diisocyanates are generally preferred for use in hydrophobic polyisocyanates employed in coating applications. Commonly used isocyanates in hydrophobic polyisocyanate polymer synthesis include 2,4- or 2,6-toluene diisocyanate (TDI), methylene bis(p-phenyl isocyanate) or 4,4′-diphenylmethane diisocyanate (MDI).

Examples of suitable substantially water-insoluble polyisocyanates

1. HDI based trimer: 1,6-hexamethylene diisocyanate based polyisocyanate:

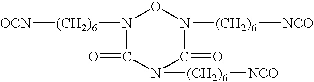

2. HDI based dimer: 1,6-hexamethylene diisocyanate based polyisocyanate:

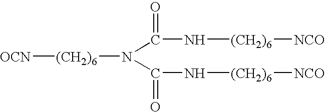

3. HDI based aliphatic polyisocyanurate (available commercially from Rhodia as “Tolonate” HDTLV).

4. HDI based aliphatic polyisocyanurate (available commercially from Rhodia as “Tolonate” HDT).

5. HDI based aliphatic polyisocyanurate (available commercially from Bayer as “Desmodur” N 3600).

6. HDI based aliphatic polyisocyanurate (available commercially from Bayer as “Desmodur” N 3300).

7. HDI based biurets (available commercially from Bayer as “Desmodur” N100 and N3200, and from Rhodia as “Tolonate” HDB.

IPDI based polyisocyanurates such as Desmodur Z 4470 SN from Bayer or Tolonate XIDT 70S from Rhodia may be used to change performance characteristics of a cured coating that incorporates a hydrophobic polyisocyanate.

(3) Waterborne Polyols (Optional)

A multicolor paint of this invention can optionally include a waterborne polyol. Such polyols are known to the prior art, do not as such constitute a part of the present invention, and embodiments are commonly commercially available.

In simplest form, a polyol is a polyhydric alcohol that contains three or more hydroxyl groups. Those containing three hydroxyl groups are glycerols, while those with more than three hydroxyl groups are termed sugar alcohols and have the general formula CH₂OH(CHOH)ₙCH₂OH where n may be from 2 to 5 inclusive. Polyols can be dissolved or dispersed in water and react with aldehydes and ketones to form acetals and ketals.

Polyols can be formed with other compounds to provide various waterborne coreactants usable in multicolor paint compositions of this invention and that are reactable with hydrophobic polyisocyanates. The following are examples of alkyds, polyesters, polyacrylics, polyurethanes and hybrid polyols:

1. TSAX 13-680, a trademark for a polyacrylic from Henkel Corp.

2. Worleecryl VP-K, a trademark for a polyacrylic from Worlee Co.

3. Setalux EPL 4708, a trademark for a polyacrylic from Akzo-Nobel Resins.

4. Setalux C-6500, a trademark for a polyacrylic from Akzo-Nobel Resins.

5. Neocryl VX-251C, a trademark for a polyacrylic from Zeneca Resins.

6. Bayhydrol LS 2235, a trademark for a polyacrylic from Bayer Corp.

7. Roshield 3275, a trademark for a polyacrylic from Rohm and Haas.

b 8. Maincote AU28, a trademark for a polyacrylic from Rohm and Haas.

9. Macrynal VSM 6285, a trademark for a polyacrylic from Vianova Co.

10. Sta-Clad 5900, a trademark for a polyacrylic from Reichhold Co.

11. SCD 19071 TX, a trademark for a polyester from Etna Products Co.

12. Resydrol VAn 6098, a trademark for a polyester from Vianova Co.

13. Kelsol 301, a trademark for a polyester from Reichhold Co.

14. Daotan VTW 6470, a trademark for a polyurethane dispersion from Vianova.

15. Hydroshield GP900WD, a trademark for an alkyd dispersion from Guertin Brothers Polymers.

Waterborne polyols are reactable with hydrophobic polyisocyanates. A waterborne polyol, as is well known, is compatible with water, can exist in various physical forms in combination with water, such as aqueous solutions, emulsions, dispersions, hybrids, or the like, and can be crosslinked.

Conveniently, and in accordance with this invention, preferably a starting waterborne polyol is admixed with a starting aqueous or water dispersed, film-forming, cross-linkable polymer system of carboxylated polymer.

Preferably, a starting waterborne polyol is preliminarily at least partially dispersed or dissolved in water or in a water-organic solvent medium. The waterborne polyol can be preliminarily admixed with a carboxylated, cross-linkable polymer. Typically, a starting aqueous dispersion of waterborne polyol contains from about 30 to about 65 weight percent of waterborne polyol and preferably this amount is in the range of about 50 to about 60 weight percent. Such a dispersion can also contain, if desired, from and including 0 up to about 8 weight percent of organic cosolvent. Mixtures of different waterborne polyols can be employed, if desired. Minor amounts of other components may sometimes be present.

A multicolor paint of this invention can incorporate into each of the dispersed phase and the continuous phase one or more aqueous dispersions of film-forming, waterborne polyol.

(4) Pressure Responsive Contact Adhesive (Optional)

A multicolor paint of this invention can optionally include a starting aqueous or water dispersible, film-forming, cross-linkable, pressure-responsive (or pressure sensitive) contact adhesive. Such adhesives are known to the prior art, do not as such constitute a part of the present invention, and embodiments are commonly commercially available. The use of such contact adhesives in previous multicolor paints is taught in the above-referenced '619 patent.

Conveniently, and in accordance with this invention, preferably a starting contact adhesive is admixed with a starting aqueous or water dispersed, film-forming, cross-linkable polymer system of carboxylated polymer.

Such a pressure-responsive contact adhesive can be a polymer which has a relatively low glass transition temperature (T_{g}). Below the T_{g}, the polymer has glass-like properties and above the T_{g} the polymer has elastomeric properties. Presently preferred such adhesives include polyurethane polymers (such as, for example, water dispersable, pressure responsive adhesives which may or may not be fully crosslinkable) and acrylic polymers. Other usable such adhesives include isoprene rubber block copolymers, and vinyl acetate polymers, such as vinyl acetate polymers which are modified with an olefin such as ethylene, or aqueous vinyl acetate polymer emulsions, or the like. However, such other adhesives may tend to suffer from certain disadvantages, such as relatively poor color in a dried coating or relatively poor ultraviolet light resistance. Aliphatic urethane polymers, for example, such as those having a polyether backbone, appear to provide excellent green strength and long term durability and are presently preferred.

Examples of preferred other (non-polyurethane) suitable water dispersible, pressure-responsive, film-forming, cross-linkable contact adhesives include acrylic polymers, particularly acrylic polymers containing incorporated butyl acrylate, or acrylic polymers containing methacrylates. Preferred such acrylic polymers are self-cross-linking.

In general, these preferred adhesives adhere to a great variety of substrates, provide clear film formation with high optical clarity, display great compatibility with multicolor paint compositions of the type involved in this invention, are non-yellowing with age, and are ultraviolet light resistant. These preferred adhesives can also be cross-linked which is presently preferred for adhesives used in the practice of this invention. Cross-linking can be variously accomplished. For example, cross-linking of the adhesives used can be accomplished through reaction with other polymeric materials present in a multicolor paint formulation, such as with an inert film-forming polyurethane polymer system, through reaction with a polyfunctional aziridine or multifunctional carbodiimide, or the like.

Preferably, as in the case of a starting water dispersed, inert film-forming, cross-linkable polymer system, a starting water dispersible, film-forming, cross-linkable pressure-responsive contact adhesive is preliminarily water dispersed or dissolved and the adhesive can be preliminarily admixed with the cross-linkable polymer system. Typically, a starting aqueous dispersion of contact adhesive contains from about 30 to about 65 weight percent of the adhesive polymer and preferably this amount is in the range of about 50 to about 60 weight percent. Such a dispersion can also contain, if desired, from and including 0 up to about 8 weight percent of organic cosolvent. Mixtures of different contact adhesives can be employed, if desired. Minor amounts of other components may sometimes be present.

Examples of suitable water dispersible, pressure-responsive, film-forming, cross-linkable contact adhesives are shown in Table II below.

TABLE II
Water Dispersible, Pressure-Responsive Adhesives

| Product | Company | Type |
|---|---|---|
| Gelva TS30 | Solutia | Vinyl acetate polymer emulsion |
| Gelva TS65 | Solutia | Vinyl acetate polymer emulsion |
| Gelva TS85 | Solutia | Vinyl acetate polymer emulsion |
| Gelva S-51 | Solutia | Vinyl acetate polymer emulsion |
| Gelva S-52 | Solutia | Vinyl acetate polymer emulsion |
| Gelva S-55 | Solutia | Vinyl acetate polymer emulsion |
| Gelva S-77 | Solutia | Vinyl acetate polymer emulsion |
| Gelva S-98 | Solutia | Vinyl acetate polymer emulsion |
| Gelva TS-70 | Solutia | Vinyl acetate polymer emulsion |
| UCARLATEX 173 | Dow | Acrylic polymer emulsion |
| UCARLATEX 174 | Dow | Acrylic polymer emulsion |
| UCARLATEX 175 | Dow | Acrylic polymer emulsion |
| Hycar 26171 | B.F. Goodrich | Acrylic polymer emulsion |
| Hycar 26146 | B.F. Goodrich | Acrylic polymer emulsion |
| Hycar 2600 x207 | B.F. Goodrich | Acrylic polymer emulsion |
| Robond P520 | Rohn & Haas | Acrylic emulsion (butyl acrylate) |
| Robond P583D | Rohn & Haas | Acrylic emulsion (butyl acrylate) |
| Luhydran A-848-S | BASF | Methacrylate dispersion |
| | | (modifies (T_{g}) |
| | | increases the glass transition |
| | | temperature at room temperature) |
| LQW10-207 | SIA Polymers | Aliphatic urethane |
| | | (backbone polyether) |

A multicolor paint of this invention can incorporate into each of the dispersed phase and the continuous phase one or more aqueous dispersions of film-forming, pressure-responsive contact adhesives may be added to each phase. One type of useful and presently preferred multicolor paint of this invention can be prepared by compounding into the continuous phase a mixture of a carboxylated polymer system with such an adhesive, and by compounding into the disperse or discontinuous phase only an inert film-forming carboxylated polymer system. The advantage of such a paint type is that the disperse phase then incorporates polymers which are of relatively lower cost than the polymers incorporated into the continuous phase, yet the product multicolor paint retains the indicated desirable characteristics.

(5) Other Components

As indicated, other components can be present in a multicolor paint of this invention.

(a) Cellulose Materials

The hydroxy (lower alkyl) cellulose materials employed in the practice of this invention as starting materials and are generally known in the prior art. As used herein, the term “lower alkyl” generally refers to an alkyl moiety containing from (and including) one through four carbon atoms. Presently most preferred for use in this invention is a cellulose type additive material such as hydroxyethyl cellulose. A suitable form of such material is available commercially under the trademark “Cellosize” from the Dow Company. Such a material is a water soluble cellulose ether which is believed to be interactive with peptized water swellable clays in aqueous gels, thereby aiding in the formation and maintenance of the disperse phase bodies in a multicolor paint composition of this invention. Hydroxypropyl cellulose is also useful, for example.

The alkali metal carboxy (lower alkyl) cellulose materials employed in the practice of this invention as starting materials are also generally known to the prior art. Presently, a most preferred alkali metal carboxy (lower alkyl) cellulose is sodium carboxy methyl cellulose. One such material is available commercially as “CMC-7-7H3SF” from the Hercules Company.

The cationic quaternized cellulose materials employed in the practice of this invention as starting materials are also generally known in the prior art. These polymeric materials are available commercially, for example, from Union Carbide Corporation under the trademark “Polymer JR” or “UCARE Polymer” in a variety of viscosity grades. These materials are also known as, and designated by, the CTFA (that is, the Cosmetic, Toiletry and Fragrance Association, Inc.) as “Polyquaternium-10” which is defined as a polymeric quaternary ammonium salt of hydroxyethyl cellulose that has been reacted with a trimethyl ammonium substituted epoxide. Such a water soluble cellulose ether is theorized to be interactive with at least one other component present in the disperse phase bodies employed in a paint of the present invention; however, the nature of this interreaction is not now known.

(b) Pigments

The pigment employed in the practice of this invention as a starting material can be selected from among the various pigments known in the prior art. Preferably, the pigment is in the form of dispersible particles having ultimate particle sizes in the submicron range. The pigment should preferably also be substantially insoluble in water or in organic solvents. While a pigment should have a positive colorant value, it can be organic, inorganic, or a mixture of organic and inorganic materials. If desired, as those skilled in the art will appreciate, the pigment can be prepared preliminarily as a slurry, dispersion, or the like in water and/or organic liquid for purposes of simple mechanical blendability. Particulate metals can be used as pigments.

Presently preferred pigments include, for example, titanium dioxide; lamp black; carbon black; bone black; phthalocyanine blue; phthalocyanine green; various organic and inorganic yellow pigments, such as, for example, D & C yellows including quinoline yellow, yellow iron oxide, and the like; various organic and inorganic red pigments, such as, for example, D & C reds including quinacridone red and red iron oxide, respectively, and the like.

(c) Clays

The dispersible, water swellable clays employed in the practice of this invention can be selected from among the various known such clays, both natural and synthetic. Preferably, the clay selected is a silicate which has an ultimate particle size in the submicron range. Examples of suitable clays include synthetic silicate clays resembling hectorite and/or saponite, montmorillonite, beidellite, nontronite, sauconite, stevensite, smectite and other inorganic minerals which are characterized by a tendency to swell by absorbing water between adjacent crystal layers, and to split into fragments capable of forming colloidal dispersions. A presently most preferred silicate clay is a synthetic sodium magnesium lithium silicate hectorite-type clay. This material is obtainable commercially from Rockwood Specialties, Inc. of Princeton, N.J. under the trademarked designation “Laponite” RD or RDS. Other suitable hectorite clays are available commercially from the R. T. Vanderbilt Company under the trademark “Veegum T,” or from the Baroid Div., National Lead Company under the trademark “Macaloid.”

The above described clays are employed in the practice of this invention in combination with a water soluble peptizing agent. Such an agent induces the clay to form a stable colloidal aqueous dispersion. Use of such an agent is conventional with such clays. Examples of known water soluble peptizing agents include ammonium hydroxide, hydrogen peroxide, sodium carbonate, sodium citrate, sodium hydroxide, sodium oxalate, sodium silicate, sodium tripolyphosphate, sodium hexametaphosphate, tetrasodium pyrophosphate, and the like. The last named peptizing agent is presently preferred for use in the practice of this invention.

(d) Reactive Curatives

When a Type 2 (two component) polyurethane dispersion is employed, a reactive curative is preferably present, as indicated above, to produce cross-linking. The reactive curative can be and preferably is a water dispersible polyisocyanate. Suitable polyisocyanates are available commercially. Presently, a most preferred polyisocyanate is an aliphatic polyisocyanate that has a molecular weight in the range of about 260 to about 264.

When the polyurethane polymer of a Type 2 dispersion contains carboxyl groups to enhance water dispersability (as is known in the art of polyurethanes), the reactive curative can (in addition to a polyisocyanate) include a wider range of reagents, such as multifunctional epoxy resins, multifunctional carbodiimides, polyfunctional aziridines, mixtures thereof, and the like.

Suitable multifunctional epoxy resins are available commercially. Such a resin can contain an incorporated amine for imparting water solubility or dispersability thereto, a presently needed property. One suitable and presently preferred multifunctional epoxy resin is available commercially as “EPI-REZ WD-510” from Resolution Performance Products.

(e) Cross-Linking Agents (Materials)

The multifunctional carbodiimides and the polyfunctional aziridines can be used to cross-link a cross-linkable carboxylated polymer as described herein and are presently preferred.

The multicolor paint compositions of this invention contain, when a cross-linkable carboxylated polymer is present in either the disperse phase or the continuous phase thereof, a cross-linking agent which is effective for cross-linking the carboxylated cross-linkable polymers involved. Preferably, the cross-linking agent is present in the same phase as that in which the cross-linkable carboxylated polymer is present. Suitable water dispersible cross-linking agents for use in this invention which can interreact with such carboxylated polymers at ambient temperatures and pressures are preferably preferred and include polyfunctional aziridines and multifunctional carbodiimides (the latter class being presently more preferred). Such materials are known in the prior art and are available commercially.

Carbodiimides (sometimes also called cyanamides) are a well-known class of organic compounds having the general structure:

R₁—N═C═N—R₂

where R₁ and R₂ are each an organic moiety. Carbodiimides cross-link with carboxylic acid groups to form N-acyl ureas.

A presently preferred carbodiimide is available commercially from Dow under the trademark “UCARLNK XL-25 SE” which is designated as “multifunctional” and is designed for use as a low-temperature cross-linking agent for polymers such as carboxylated polymers.

Aziridines are organic compounds based on the ring structure:

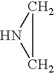

A presently preferred cross-linking polyfunctional aziridine is “ZAMA-7” which is designated “polyfunctional” and is available commercially from Hoechst Celanese and also from Virginia Chemicals. This material also is designed for use as a low-temperature cross-linking agent for polymers such as carboxylated polymers.

(f) Organic Liquids

As indicated, the disperse phase bodies and the pigmented, unpigmented or colored continuous phase of this invention preferably each incorporate a water-miscible organic liquid as a cosolvent (or codispersant) in combination with the water employed therein. Any convenient water-miscible organic liquid can be used, but presently preferred liquids include ester alcohols, such as a material available commercially from Eastman Kodak Company under the trademark “Texanol”; glycol ethers, such as diethylene glycol butyl ether, which is available from Union Carbide Corporation under the trademark “Butyl Carbitol”; and ethylene glycol butyl ether, which is available from Union Carbide Corporation under the trademark “Butyl Cellosolve”; heterocyclics, such as N-pyrrolidine (also identified as N-methyl-2-pyrrolidone or NMP) which is available from ISP Corp., and the like, can also be used.

As indicated, the hydrophobic polyisocyanate is preferably preliminarily dissolved in a water immiscible organic liquid. Presently preferred water immiscible organic liquids include esters, such as ethyl acetate, n-propyl acetate, n-butyl acetate, and the like, and ether esters, such as propyl methoxy acetate, and the like.

(g) Neutralizer Base

An optional but preferred component of a multicolor paint of this invention is a neutralizer base which is used for reasons of pH control and buffering. Examples of suitable neutralizers include aqueous potassium hydroxide, ammonium hydroxide, triethanolamine, dimethylethanol amine, mixtures thereof, and the like. When employed, the amount of neutralizer used can range from greater than zero up to about 0.6 weight percent on a 100 weight percent total paint composition basis. A neutralizer base, when used, can be added at any convenient point during the blending sequence; for example, the neutralizer base can be added to Composition A or to the final mixture of gel phase composition and continuous phase at the time when such are being blended together. It is presently preferred to have a product paint composition wherein the continuous phase has a pH in the range of about 8 to about 9 and similarly for the discontinuous (or disperse) phase. The neutralizer base can be preliminarily prepared as an aqueous solution or dispersion for ease in blending.

(c) Preparation of Blending Compositions

In preparing a multicolor paint composition of this invention, it is convenient and presently preferred to prepare four compositions initially, which are designated respectively as “Composition A,” “Composition B,” “Composition C” and “Composition D,” each of which is described below.

As illustrated in the appended drawing, in the preferred practice of the invention, a preliminarily prepared hydrophobic polyisocyanate solution is preferably added either to (a) a preliminarily prepared intermediate disperse phase composition (prepared as hereinbelow explained) or to (b) a preliminarily prepared multicolor paint composition (prepared as hereinbelow explained). In the practice (a), a preliminarily prepared disperse phase containing the admixed hydrophobic polyisocyanate is then mixed with a preliminarily prepared intermediate continuous phase composition (prepared as hereinbelow explained) to produce a product multicolor paint composition of the invention. In the practice (b), the resulting multicolor paint composition comprises a product of the invention.

In an alternative practice (not shown in the appended flow sheet drawing), a preliminarily prepared hydrophobic polyisocyanate solution is added to an intermediate continuous phase composition (prepared as hereinbelow explained). The resulting continuous phase composition is then admixed with a preliminarily prepared intermediate disperse phase composition (prepared as hereinbelow explained) to produce a product multicolor paint composition of the invention. If desired, a preliminarily prepared hydrophobic polyisocyanate solution is added to the intermediate disperse phase composition (prepared as hereinbelow explained) before the intermediate disperse phase composition is admixed with the resulting continuous phase composition. It appears that sometimes when a solution of hydrophobic polyisocyanate is admixed with a continuous phase composition that is clear (that is, substantially transparent), the resulting continuous phase composition becomes opaque but is uniform in composition and consistency for reasons that are not presently known.

(1) Composition A

Composition A is conveniently prepared by preliminarily dissolving the hydroxy (lower alkyl) cellulose (presently preferred) and/or the alkali metal carboxy (lower alkyl) cellulose in a starting water dispersed, inert film-forming, cross-linkable polymer system. The carrier liquid is preferably a water/organic cosolvent mixture. Thereafter, the pigment when used is conveniently dispersed in the resulting mixed dispersion.

A carboxylated polymer system, a polyurethane polymer system, or a mixture thereof can be employed, as above indicated, in a Composition A in dispersed or dissolved form. The total amount of water dispersed, film-forming, cross-linkable polymer system employed in a Composition A preferably falls in the range of about 10 to about 45 weight percent (based on 100 weight percent total of a Composition A). However, the amount individually of either polymer system that is employed can range from and including 0 up to about 45 weight percent (same basis) in a Composition A. Preferably this polymer system in a Composition A comprises an acrylic polymer system.

The amount of cross-linking agent and/or reactive curative added when the carboxylated polymer and/or polyurethane polymer is used is preferably at least sufficient to cross-link the polymer system present when the polymer, the cross-linking agent and the reactive curative are dried from an aqueous dispersion at room temperature.

Typically, but preferably, Composition A may also include a hydrophobic polyisocyanate, a pressure contact adhesive, and/or one or more of the various optional additives of the type and in the respective minor amounts conventionally used in paint formulations, such as plasticizers, bonding agents, anti-foaming agents, wetting agents, fungicides, neutralizers, and/or the like. It can be regarded as a feature of the present invention that such additives can be used effectively in a multicolor paint of this invention and can achieve their respective known effects without adversely affecting such desirable paint properties as formulatability, storage stability, applied dried coating water resistance, disperse phase body structural integrity, or the like.

Examples of suitable plasticizers preferably include monomeric plasticizers, such as phthalates like dibutyl phthalate, diisodecyl phthalate, dioctyl phthalate, tricresyl phosphate, butyl benzyl phthalate, and the like. Other suitable monomeric plasticizers can be selected from among the adipates, sebacates, glycolates, castor oils, and the like.

Examples of suitable bonding agents include epoxidized siloxanes, such as a glycidyl silane like glycidoxy trimethoxy silane, organosilanes such as are available commercially, for example, from OSI, Dow Corning, and the like. Suitable bonding agents also include organotitanates and organozirconats such as are available commercially, for example, from Kenrich Petrochemicals, Inc. and the du Pont Company.

Examples of suitable anti-foaming agents (defoamers) include the materials available commercially from Cognis under the trademarks “Foamaster VL,” “Dehydran 1293,” “Nopco NXZ,” and the like.

Examples of suitable wetting agents include polycarboxylic acid salts such as are available from Rohm and Haas under the trademark “Tamol” 165 and also the materials that are available commercially from Rohm and Haas under the trademark “Triton,” especially the products CF10 and X100.

The preferred compositional characteristics of a Composition A are shown in Table III (below). When, as in Table III, a composition can contain both a reactive curative and a cross-linking agent, it will be understood that the amount of cross-linking agent and/or reactive curative used is for purposes of causing the polymer system present to cross-link. However, the amount of reactive curative and/or cross-linking agent employed in relation to a given carboxylated polymer is usually not separately shown.

TABLE III
COMPOSITION A

| | | Weight Percent | |
|---|---|---|---|
| | | (100% Basis¹) | |
| ID | | Broad | Preferred |
| No. | Component² | (about) | (about) |
| 1 | Carboxylated polymer system | 10-40 | 14-35 |
| 2 | Cross-linking agent/Reactive curative | 0-10 | 2.5-3.0 |
| 3 | Hydroxy (alkyl) cellulose and/or alk. | 0.5-2 | 0.75-1.25 |
| | metal carboxyl alkyl cellulose | | |
| 4 | Hydrophobic polyisocyanate | 0.2-35 | 4.5-16 |
| 5 | Pressure responsive adhesive | 0-10 | 0.1-5 |
| 6 | Waterborne polyol | 0-40 | 0-20 |
| 7 | Water | 20-80 | 40-65 |
| 8 | Organic cosolvent | 0-15 | 4.0-8.0 |
| 9 | Water immiscible liquid | 0-30 | 0.1-9.5 |
| 10 | Pigment | 0-30 | 5-20 |
| 11 | Monomeric plasticizer | 0-3 | 1-2 |
| 12 | Bonding agent | 0-0.5 | 0.10-0.3 |
| 13 | Anti-foaming agent | 0-0.5 | 0.10-0.3 |
| 14 | Wetting agent | 0-1.0 | 0.25-0.75 |
| | (TOTAL) | (100.00) | (100.00) |

¹Weight ranges enclosed in parentheses are not included in the 100 weight percent total composition basis since such ranges are associates with (i.e., are incorporated into) item 1 (the polymer system).
²Components 11-14 are optional but preferred secondary ingredients.

Characteristically, Composition A preferably has a viscosity that is believed to be in the range of about 10,000 cps to about 30,000 cps (centipoises) measured with a Brookfield viscometer at 25° C. operating at 20 rpm spindle speed with a No. 4 spindle.

Preferably, the water employed in the practice of this invention is preliminarily filtered and is either deionized or distilled. A present preference is to employ a water and organic water-miscible cosolvent medium comprised of about 85 to about 90 weight percent water with the balance up to 100 weight percent on a total solvent composition weight basis thereof being the cosolvent (as above characterized).

(2) Composition B

Composition B is prepared by dissolving the quaternized cellulose ether in water. The preferred compositional characteristics of Composition B are identified in Table IV below:

TABLE IV
COMPOSITION B

| | | Weight Percent | |
|---|---|---|---|
| | | (100% Basis) | |
| ID | | Broad | Preferred |
| No. | Component | (about) | (about) |
| 1 | Water | 55-99.5 | 98 |
| 2 | Quaternized celluose ether | 0.5-5 | 2 |
| | (Total) | (100.00) | (100.00) |

Characteristically, Composition B preferably has a viscosity that is believed to be in the range of about 50,000 to about 55,000 centipoises measured at 25° C. with a Brookfield viscometer using a No. 4 spindle operating at a spindle speed of 20 rpm.

(3) Composition C

Composition C is prepared by dissolving a peptizing agent in water and then dispersing a water swellable clay in the resulting solution. In general, the respective amount employed of each material is such that the resulting aqueous system forms a gel. As indicated above, the presently most preferred clay is a synthetic sodium magnesium lithium hectorite clay, and the presently most preferred peptizing agent is tetrasodium pyrophosphate. Composition C is preferably characterized as shown in Table V (below):

TABLE V
COMPOSITION C

Weight Percent
(100% Basis)

| ID | | Broad | Preferred |
|---|---|---|---|
| No. | Component | (about) | (about) |
| 1 | Water | 88-95 | 89.4 |
| 2 | Water Swellable Clay | 5-10 | 9.5 |
| 3 | Peptizing Agent | 0.5-2 | 1.1 |
| | (Total) | (100.00) | (100.00) |

Characteristically, Composition C preferably has a viscosity that is believed to be in the range of about 80,000 to about 90,000 cps measured at 25° C. with a Brookfield viscometer operating with a No. 4 spindle at a spindle speed of 20 rpm. Characteristically also, Composition C is a thixotropic gel.

(4) Composition D

Composition D is conveniently and preferably prepared by dispersing (including preferably dissolving) the water dispersed, film-forming, cross-linkable polymer system and other components (such as identified below in Table IX) in a water/cosolvent mixture. Thereafter, a peptizing agent is dissolved in water, a water swellable clay is dispersed in the resulting solution and the resulting mixture is then admixed with the water/cosolvent mixture to formulate a Composition D. The dispersed polymer system, as in the case of Composition A, is selected from the group consisting of a polyurethane polymer system, a carboxylated polymer system, and mixtures thereof. In the case of Composition D, the dispersed polymer system preferably comprises on a 100 weight percent total dispersed polymer solids basis about 75 to and including 100 weight percent of the polymer system, and correspondingly, from and including 0 up to about 25 weight percent of the cross-linking agent or reactive curative. Most preferably, the polymer system is comprised of an acrylic polymer system.

Composition D is preferably characterized as shown in Table VI:

TABLE VI
COMPOSITION D

| | | Weight Percent | |
|---|---|---|---|
| | | (100% Basis¹) | |
| ID | | Broad | Preferred |
| No. | Component | (about) | (about) |
| 1 | Carboxylated polymer system | 0.5-40 | 10-30 |
| 2 | Cross-linking agent/Reactive curative | 0-5 | 0.2-1.5 |
| 3 | Hydrophobic polyisocyanate | 0.2-25 | 4.5-16 |
| 4 | Pressure responsive adhesive | 0-30 | 5-25 |
| 5 | Waterborne polyol | 0-40 | 0-30 |
| 6 | Clay | 1.5-5 | 2-4 |
| 7 | Peptizing agent | 0.1-0.8 | 0.15-0.2 |
| 8 | Anti-foaming agent | 0-0.25 | 0.1-0.15 |
| 9 | Wetting agent | 0-0.25 | 0.1-0.15 |
| 10 | Colloidal silica | 0-5 | 0.5-3 |
| 11 | Organo functional silane | 0-0.25 | 0.04-0.2 |
| 12 | Pigment | 0-30 | 5-20 |
| 13 | Organic cosolvent | 0-15 | 4-8 |
| 14 | Water miscible liquid | 0-30 | 0.1-9.5 |
| 15 | Water | 30-70 | 40-65 |
| | (Total) | (100.00) | (100.00) |

¹Weight ranges enclosed in parentheses are not included in the 100 weight percent total composition basis since such ranges are associates with (i.e., are incorporated into) item 1 (the polymer system).

Characteristically, Composition D preferably has a viscosity that is believed to be in the range of about 500 to about 5,000 centipoises measured at 25° C. with a Brookfield viscometer using a No. 4 spindle at a spindle speed of

(d) Blending Procedures to Prepare Product Paint Compositions

As described herein, the multicolor paint compositions of this invention contain hydrophobic polyisocyanate. Characteristically, the hydrophobic polyisocyanate, as a starting material, is in a solution which is admixed with a composition as described herein to achieve a produce multicolor paint composition.

The water-in-water multicolor paint compositions of this invention incorporate a disperse phase distributed in a continuous phase. Each phase contains a film-forming, cross-linkable, water dispersed, polymer system selected from the class consisting of a carboxylated polymer, a polyurethane polymer, and mixtures thereof.

Compositions A, B and C are usable in various combinations to prepare disperse phase compositions. A Composition A is blended with a Composition B in a weight ratio range of about 85:15 to about 80:20 of said Composition A to said composition B, or with a Composition C in a weight ratio range of about 85:15 to about 80:20 of said Composition A to said Composition C, or with a mixture of a Composition B and a Composition C in a weight ratio range of about 70:15:15 to about 80:10:10 of said Composition A to said Composition B to said Composition C so as to prepare a disperse phase gel composition which characteristically has a viscosity in the range of about 25,000 to about 85,000 centipoises measured with a Brookfield viscometer operating at 20 rpm at 25° C. with a No. 4 spindle. Then such a resulting disperse phase get composition is admixed with a Composition D in the presence of the hydrophobic polyisocyanate. During the admixing, the disperse phase get composition is broken up under mixing shear force to form disperse phase bodies in a continuous phase comprised of Composition D, thereby to comprise a multicolor paint.

A starting hydrophobic polyisocyanate is preferably and conveniently preliminarily dissolved in a water-immiscible organic solvent liquid, and the solution is added to and admixed with at least one of the continuous phase (preliminarily), the discontinuous phase (preliminarily), or the multicolor paint comprised of the continuous and the discontinuous phases. Usually, the total amount of hydrophobic polyisocyanate employed in a product multicolor paint (that is, both the continuous and the discontinuous phases of a multicolor paint composition) ranges from about 1 to about 40 weight percent on a 100 weight percent total multicolor paint composition weight basis. Because of the reactivity characteristics of the hydrophobic polyisocyanate, it is preferred to add most or even substantially all of the hydrophobic polyisocyanate to a multicolor paint having already mixed (formed) continuous and discontinuous phases. Preferably a Composition A initially contains no more than about 0.2 weight percent on a 100 weight percent total Composition A basis though a larger amount can be present. Similarly, preferably a Composition D initially contains no more than about 0.2 weight percent on a 100 weight percent total Composition D basis though a large amount can be present.

Preferably, a small amount of the hydrophobic polyisocyanate is always present at least in the continuous phase. Preferably, at least one of either the discontinuous or the continuous phase, or more preferably both phases, contains hydrophobic polyisocyanate in an amount that falls in the range of about 5 to about 20 weight percent on a 100 weight percent total multicolor paint composition product basis. If desired, one may add hydrophobic polyisocyanate to any one of the Compositions A, B, C and D as initially prepared or before subsequent blending. However, as indicated, because of its reactivity characteristics, the hydrophobic polyisocyanate is preferably added to a multicolor paint composition after the preparation or the blending of Compositions A, B, C and/or D with other compositions as described herein. The hydrophobic polyisocyanate be introduced into either or both the discontinuous and the continuous phases, and/or into a multicolor paint composition, by merely adding (admixing) the hydrophobic polyisocyanate therewith. The amount of polyisocyanate in a product multicolor paint can be be accurately determined since apparently the polyisocyanate reacts with other components in the paint before or during application of the paint as a coating. The amount of hydrophobic polyisocyanate in, for example, an applied and dried coating, and the amount of hydrophobic polyisocyanate in, for example, the disperse phase of a product multicolor paint, can be accurately measured, if desired.

Thus, as above indicated:

The hydrophobic polyisocyanate is preferably initially dissolved in a water immiscible organic liquid in which the hydrophobic polyisocyanate is initially soluble, the water immiscible organic liquid being miscible with the intended paint components involved.

At least a portion of the hydrophobic polyisocyanate is initially added to at least one the Composition A or the Composition D or both the Composition A and the Composition D.

Preferably at least a portion of the hydrophobic polyisocyanate employed in a given multicolor paint composition is added (mixed) concurrently with a disperse phase gel composition and a Composition D at the time of their mixing, and preferably most of such hydrophobic polyisocyanate is added during such mixing. Most preferably, a portion of the dissolved hydrophobic polyisocyanate (in the immiscible organic liquid), and preferably substantially all of such hydrophobic polyisocyanate, is added to a preformed mixture of produced by mixing together a disperse phase gel composition with a Composition D, as taught herein.

A present preference is to select the hydrophobic polyisocyanate from the group consisting of HDI-based NCO's. Mixtures of hydrophobic polyisocyanates can be employed, if desired, with mixtures of film forming, cross-linkable, water dispersed carboxylated polymer systems. However, a present preference is to employ hydrophobic polyisocyanate with carboxylated acrylic resins and preferably with product multicolor paint compositions wherein the film forming, cross-linkable, water dispersed polymer system comprises a carboxylated acrylic resin.

Optionally, in a water-in-water multicolor paint of this invention, a water-dispersed, film-forming, cross-linkable, pressure-responsive contact adhesive (as characterized above) can also be added to and admixed with the continuous phase (preliminarily), the discontinuous phase (preliminarily), and/or the multicolor paint comprised of the continuous and the discontinuous phases. When employed, usually, the total amount of contact adhesive present in a multicolor paint (including both the continuous and the discontinuous phases) ranges from greater than 0 to about 30 weight percent on a 100 weight percent total multicolor paint composition weight basis, and preferably the amount of contact adhesive so employed is in the range of from about 5 to about 25 weight percent (same basis). More preferably, the discontinuous phase contains no more than about 1 weight percent on a 100 weight percent total discontinuous phase basis, and the continuous phase contains no more than about 20 weight percent on a 100 weight percent total continuous phase basis, of contact adhesive. When present, preferably, the contact adhesive is always present at least in the continuous phase, when present, preferably, at least one of either the discontinuous or the continuous phase contains contact adhesive in an amount equal to the amount this is above for the total weight percent range indicated.

Preferably, the contact adhesive is selected from the group consisting of polyurethanes and acrylic polymers. Mixtures of contact adhesives can be employed, if desired, with mixtures of film forming, cross-linkable, water dispersed polymer systems. However, a present preference is to employ a contact adhesive with admixture with carboxylated acrylic resins and preferably with product multicolor paint compositions.

Conveniently and preferably, blending is carried out with conventional physical mixing equipment, such as with a Cowles blade operating in a range of from about 450 to 1500 rpm in a mixer.

Referring to the flow sheet in the appended drawing, which is submitted to be self-explanatory, it is seen that a Composition A is blended with either Composition B or Composition C, and preferably with both Compositions B and C, to prepare a disperse phase composition which is homogeneous. The preferred weight ratios of Composition A to such Compositions B and/or C, as the case may be, and also the preferred viscosities of the resulting dispersed phase blend homogeneous compositions, are as shown in Table VII (below):

TABLE VII
DISPERSE PHASE COMPOSITIONS

| | | Preferred Approx. | |
|---|---|---|---|
| | Disperse Phase | Weight Ration of | Preferred Approx. |
| ID | Composition of | Other Composition(s) | (CPS) of Blended |
| No. | (B or B + C) | Disperse Phase | Composition¹ |
| 1 | A + B | 85:15 to 80:20 | 25,000-27,500 |
| 2 | A + C | 85:15 to 80:20 | 30,000-33,000 |
| 3 | A + B + C | 80:10 (to at least 35,000 cps²) | 70:15:15 |

¹All viscosities are measured in centipoises at 25° C. with a Brookfield viscometer using a No. 4 spindle operating at 20 rpm.
²Most preferably, this viscosity is not greater than about 85,000 centipoises (so measured).

The disperse phase compositions are conveniently prepared using simple mechanical blending procedures and conventional mixing apparatus with the amount of mixing shear force used being at least sufficient to produce a uniform and homogeneous product blend. As shown in Table VII, the viscosity of a resulting disperse phase composition appears to be characteristically greater than that of the Composition A that is incorporated therein. A disperse phase gel composition characteristically has a viscosity in the range of from about 25,000 to about 85,000 centipoises measured with a Brookfield viscometer operating at 20 rpm at 25° C. with a No. 4 spindle.

As indicated, preferred disperse phase compositions incorporate all three of Compositions A, B and C. While such an (A+B+C) composition can be prepared by any convenient procedure, such as by first blending together Compositions A and B or Compositions A and C, and then further combining with the resulting blend a third Composition (either Composition C or B, as the case may be), it is presently preferred to first mix together Composition A and C in a weight ratio within the range shown in Table VII and then thereafter to mix Composition B therewith using a weight ratio sufficient to achieve a mixing weight ratio as shown in Table VII for all three of Compositions A, B and C.

An (A+B+C) composition characteristically appears to have a viscosity that is greater than either an (A+B) composition or an (A+C) composition. It is theorized, and there is no intent herein to be bound by theory, that the reason for this increase is that the quaternized cellulose ether has reacted in some now unknown manner with at least one component present in the (A+B+C) composition, perhaps with the polyurethane polymer, and, if present, the carboxylated cross-linkable polymer. An (A+B+C) composition, particularly one prepared by the foregoing preferred procedure, appears to have better tack and elasticity characteristics than other such disperse phase compositions.

The (A+B), (A+C) and (A+B+C) disperse phase compositions of the present invention all appear to be novel over all known prior art teachings pertaining to multicolor aqueous disperse phase compositions, and to have higher viscosities than any previously known aqueous pigmentable composition of the type usable for the disperse phase in multicolor paints.

The (A+B), (A+C) and (A+B+C) disperse phase compositions are used to make multicolor paints of the invention by the following procedure:

First, at least two different (A+B), (A+C) or (A+B+C) compositions are each prepared, each preferably being made by the preferred procedure described above. Each (A+B), (A+C) and (A+B+C) composition of the plurality is prepared using a differently colored pigment; thus, each composition has a different apparent color. Preferably, all of the compositions used in any given multicolor paint are of the same type, that is, (A+B), (A+C) and (A+B+C).

Next, the plurality of the different (A+B), (A+C) or (A+B+C) compositions are blended together with a preformed continuous phase composition which is comprised of a clear or pigmented vehicle as in Composition D. In general, Composition D used as a continuous phase in a multicolor paint of this invention should have at the time of blending with (A+B), (A+C) or (A+B+C) compositions a viscosity that is preferably in the range of about 3,000 to about 7,000 cps as measured at 25° C. with a Brookfield viscometer operating at 20 rpm and using a No. 4 spindle. Such viscosity is more preferably in the range of about 5,000 to about 6,000 cps.

In general, the viscosity of the continuous phase is less than the viscosity of the gel phase composition. Preferably, the ratio of the viscosity of the continuous phase composition to the viscosity of each of the disperse phase compositions (comparably measured) is in the range of about 1:5 to about 1:10 with a viscosity ratio range of about 1:7 to about 1:8.5 being presently more preferred.

The respective amounts of the individual (A+B), (A+C) and (A+B+C) compositions employed in a given multicolor paint can be varied according to the artistic preference of the formulator. Preferably, the weight ratio of the total weight of all (A+B), (A+C) and/or (A+B+C) compositions employed in a given multicolor paint of this invention to the weight of Composition D employed in such paint is in the range of about 1:1 to about 6:4, although larger and smaller weight ratios can be used, if desired.

In a product multicolor paint of this invention, such viscosity differences between the discontinuous phase compositions and the continuous phase compositions, and such a total weight ratio of weight of total discontinuous phase compositions to weight of continuous phase composition are now believed to be desirable because such appear to result in production of a product paint wherein the disperse phase bodies form and remain suspended and discrete during subsequent paint storage.

Disperse phase (A+B), (A+C) and (A+B+C) compositions can be blended with a continuous phase composition in any order or manner. During blending, the disperse phase compositions break up and disperse to form discontinuous phase bodies in the continuous phase. The mixing shear force used in the blending is inversely proportional to the average size of the disperse phase bodies formed. The resulting dispersion constitutes a multicolor paint according to this invention.

The discontinuous phase bodies are characterized by what is believed to be unusual and surprisingly greater structural integrity compared to the structural integrity of prior art discontinuous phase bodies, such as the bodies taught, for example, in Sellars et al. U.S. Pat. No. 3,950,283.

In the present invention, a continuous phase which includes a cross-linkable Composition D generally exhibits superior film properties compared to corresponding continuous phases of the prior art which do not contain hydrophobic polyisocyanate.

Various mixing procedures can be employed, as those skilled in the art will appreciate. When introducing the hydrophobic polyisocyanate into a multicolor paint and/or its component precurser compositions, such as, for example, Compositions A, B, C and D as above described, it is preferred that gentle mixing conditions be employed so as to avoid disrupting or breaking individual discontinuous phase particles or droplets (also sometimes called bodies or flecks). For example, when small volumes are involved, it is convenient and preferred to accomplish such a mixing using hand stirring with a paint mixing stick.

When, for example, a multicolor paint of this invention is prepared wherein the discontinuous phase color bodies are to have different sizes relative to one another, one can prepare the different sized discontinuous phase bodies in separate mixing operations with different Composition D batches using different mixing shear forces. Thereafter, the different and separately prepared continuous/discontinuous phase dispersion compositions can be blended together. Preferably, a mixing shear force is used in such a blending which is not larger than that used to make the largest size disperse phase bodies desired in the resulting mixed dispersions.

Study of the (A+B), (A+C) and (A+B+C) compositions, whether or not the hydrophobic polyisocyanate is present, indicates that each is a gel and remains a gel when formed into disperse phase bodies in a multicolor paint composition of the invention. The gel bodies formed from (A+B+C) compositions are believed to have the greatest internal structural integrity or strength.

To a resulting dispersion wherein Composition D comprises the continuous phase, with the discontinuous phase comprising one of the blends of (a) Composition A and Composition B, (b) Composition A and Composition C, and (c) Composition A and Composition B and Composition C, a hydrophobic polyisocyanate is added (blended) with admixing to produce a product composition wherein, on a 100 weight percent product composition weight basis, the amount of hydrophobic polyisocyanate ranges from about 4.5 to about 16 weight percent, the amount of film-forming, cross-linkable, water dispersed, polymer system of carboxylated polymer, a polyurethane polymer, and/or polymer mixture thereof ranges from about 15 to about 30 weight percent, and the amount of all other components comprises the balance up to 100 weight percent.

The mixing of a disperse phase gel composition with a Composition D is, as above explained, carried out in the presence of said hydrophobic polyisocyanate. The total amount of the hydrophobic polyisocyanate present based on 100 weight percent total of all components present during mixing is preferably in the range from greater than 0 to about 25 weight percent. Usually, the amount of the hydrophobic ployisocyanate present is preferably initially at least about 1 weight percent. The respective amounts of a first disperse phase gel composition and of a Composition D (or fourth composition) are such that usually the ratio of the viscosity of such fourth composition to the viscosity of such first disperse phase composition is in the range of about 1:5 to about 1:10. Usually, the mixing shear force used in such mixing is sufficient to (a) break up such first disperse phase gel composition into discrete gel bodies dispersed in such fourth composition, and (b) disperse the hydrophobic polyisocyanate. The mixing shear force applied is usually inversely proportional to the average size of said so formed disperse phase bodies, thereby to produce said multicolor paint.

(e) Product Multicolor Paint Characteristics

Independently of whether or not the hydrophobic polyisocyanate is present (as explained above), once the (A+B), (A+C) and/or (A+B+C) compositions are broken up by mixing in a Composition D, the resulting disperse phase bodies apparently cannot and do not separate to reform the respective original (A+B), (A+C) and/or (A+B+C) compositions. Though the reasons are not clear, and there is not intent herein to be bound by theory, the disperse phase particles or bodies may each have a cross-linked surface and internal structure, and also an interfacial bonding relationship may exist between the continuous phase and the discontinuous phase bodies. Colloidal forces may be involved. No discrete interfacial material layer, such as a shell wall or the like, apparently exists between the disperse phase bodies and the continuous phase.

Typically, the disperse phase body particle sizes in a multicolor paint of this invention have a size in the range of about 0.2 to about 15 mm, but larger and smaller body or particle sizes can be employed, if desired.

The multicolor paint compositions of this invention that contain the hydrophobic polyisocyanate are characterized by having indefinitely long storage stability, including shelf, shipping, thermal, and vibrational (mixing) aspects.

The excellent strength and stability characteristics of a multicolored paint composition of this invention provide a composition which can be brushed, rolled or sprayed using the relatively high shear forces that are characteristically exerted upon a paint formulation being so applied without disperse phase color body breakdown.

While a multicolor paint formulation of this invention characteristically contains at least two distinct colors, those skilled in the art will appreciate that a particular multicolor paint formulation may contain many different classes of distinctly separately colored or non-colored disperse phase bodies, perhaps six or more, each individual identically colored group of discrete disperse phase bodies having been separately preliminarily prepared as an (A+B), (A+C) or (A+B+C) disperse phase composition as hereinabove described, before the disperse phase composition is blended into the continuous phase. Various ratios and proportions of respective (A+B), (A+C) and (A+B+C) compositions relative to one another can be used as desired in blending, as indicated above.

A neutralizer base is commonly employed in preparing a multicolor paint of this invention as those skilled in the art will readily appreciate.

In a product multicolor paint of this invention that contains hydrophobic polyisocyanate as disclosed herein, at least one of either the total discontinuous phase or the continuous phase thereof can optionally contain from and including 0 to about 25 weight percent on a 100 weight percent total phase basis of water dispersed carboxylated polymer (as described above) plus sufficient water dispersed cross-linking agent (as described above) to cross-link this carboxylated polymer when the carboxylated polymer and the cross-linking agent are dried from an aqueous dispersion at room temperature. Usually the total amount of this cross-linking polymer in both phases of a product multicolor paint is not more than about 3 weight percent on a total 100 weight percent product paint basis.

The compositional characteristics for a preferred and illustrative class of multicolor paint compositions of this invention (expressed on a total composition basis including both the continuous phase and the discontinuous phase) are summarized in Table VIII below:

TABLE VIII
MULTICOLORED PAINT COMPOSITIONS

| | | Weight Percent (100% Basis¹) | | | |
|---|---|---|---|---|---|
| ID | | Presently Most | Presently Most | Preferred | Broad |
| No. | Component | Preferred | Preferred | Range | Range |
| 1 | Carboxylated polymer | 28.19 | 30.81 | 20-50 | 15-55 |
| | system | | | | |
| 2 | Hydroxy (alkyl) cellulose | 0.21 | 0.31 | 0.2-1.25 | 0.1-2.0 |
| 3 | Hydrophobic | 8.79 | 8.79 | 2-25 | 1-40 |
| | polyisocyanate | | | | |
| 4 | Pressure responsive | — | 0-4.46 | 0-10 | 0-25 |
| | adhesive | | | | |
| 5 | Waterborne Polyol | — | — | 0-50 | 0-55 |
| 6 | Pigment | 4.99 | 7.14 | 2-20 | 0-30 |
| 7 | Quaternized cellulose ether | 0.13 | 0.13 | 0.05-2 | 0.01-25 |
| 8 | Colloidal silica | 2.66 | 1.07 | 0.5-3 | 0-5 |
| 9 | Clay | 1.39 | 2.68 | 0.1-10 | 0-12 |
| 10 | Peptizing agent | 0.25 | 0.31 | 0.1-1.0 | 0-1.5 |
| 11 | Organo functional silane | 0.06 | 0.01 | 0.002-0.015 | 0-0.02 |
| 12 | Miscible organic cosolvent | 4.43 | 6.47 | 1.5-7.5 | 0-10 |
| 13 | Immiscible organic liquid | 1.93 | 1.93 | 0-25 | 0-30 |
| 14 | Water | 44.73 | 35.27 | 20-80 | 15-85 |
| 15 | Wetting agent | 0.14 | 0.22 | 0.10-0.50 | 0.05-1 |
| 16 | Anti-foaming agent | 0.08 | 0.13 | 0.05-0.50 | 0.01-1 |
| | (Defoamer) | | | | |
| 17 | Bonding agent | — | 0.09 | 0.05-0.25 | 0.01-0.3 |
| 18 | Neutralizer | 0.07 | 0.18 | 0.05-0.50 | 0.01-1 |
| 19 | Monomeric Plasticizer | 1.71 | — | 1-5 | 0-10 |
| 20 | Polyethylene wax | 0.27 | — | 0.1-1 | 0-5 |
| 21 | Biocide | 0.07 | — | 0.05-0.1 | 0.01-.02 |
| | (Total Weight Percent) | (100.00) | (100.00) | (100.00) | (100.00) |

¹Weight ranges enclosed in parenthesis are not included in the 100 weight percent total composition basis since such ranges are associated with (i.e., are incorporated into) item 1 (the polymer).

It will be appreciated that a multicolor paint of the present invention can generally be applied by any conventional application method desired utilizing spraying, brushing, roller, pad, or the like.

As the applied paint coating dries on a surface, the film-forming polyurethane polymer in combination with the other components present form a continuous film or coating in which the disperse phase bodies become located typically in adjacent relationship to one another. Both the water and the organic cosolvent (if present) evaporate. The resulting coating becomes substantially fully cross-linked.

As the applied paint coating dries on a surface, the film-forming carboxylated polymer in combination with the same polymers present form a continuous film or coating in which the disperse phase bodies become located typically in adjacent relationship to one another.

A product dried coating displays excellent properties, especially water resistance, as well as abrasion (wear) resistance, thermal stability, washability, surface smoothness, and the like.

### EMBODIMENTS

The invention is further illustrated by the following Examples.

### EXAMPLES 1 and 2

### Preparation of First and Second “Composition “A”

Two embodiments of “Composition A” are prepared by blending together the following components in the respective amounts indicated using a Cowles blade operating at about 450 to about 1500 rpm in a mixer, as summarized in the following Table IX:

TABLE IX
FIRST & SECOND “COMPOSITION A”

| | Ex. 1 | Ex. 2 |
|---|---|---|
| Component | (wt %) | (wt %) |
| Dispersed Carboxylated Polymer | 36.07 | 40.17 |
| (Pliolite 7103 from Eliokem) | | |
| Water | 34.62 | 38.56 |
| Wetting agent (Tamol 165 from Rohm & Haas) | 0.51 | 0.57 |
| Defoamer (Foamaster NXZ from Cognis) | 0.2 | 0.22 |
| Hydroxethyl cellulose (Natrosol from Aqualon) | 0.71 | 0.79 |
| Titanium dioxide (Dupont R-900) | 19.76 | |
| Black iron oxide (Bayferrox 316 from Bayer) | | 8.72 |
| Barium sulfate (Barytes) | | 1.91 |
| Organo functional silane (A-187) | 0.2 | 0.22 |
| Ammonium hydroxide (28% ammonia) | 0.25 | 0.28 |
| Bacteriocide (Nuosept 95 or Rozone 2000) | 0.2 | 0.22 |
| Polyethylene wax (Jonwax 26 or Shamrock | 1 | 1.12 |
| wax) | | |
| Monomeric plasticizer (butylbenzylphthalate) | 1.72 | 1.92 |
| Organic cosolvents (texanol from Eastman or | 4.76 | 5.30 |
| butyl cellosolve from Dow) | | |
| (Total Weight Percent) | (100.00) | (100.00) |

The “Composition A” of Example 1 is white in color and its Brookfield viscosity is believed to be in the range of about 10,000 to about 25,000 cps measured at 25° C. using a No. 4 spindle operating at 20 rpm, and the “Composition A” of Example 2 is black in color and its Brookfield viscosity is believed to be in the range of about 10,000 to about 30,000 cps similarly measured.

### EXAMPLE 3

### Preparation of Clear “Composition A”

A clear “Composition A” is prepared by blending together the following components in the respective amounts indicated using a Cowles blade operating at about 450 to about 1500 rpm in a mixer.

TABLE X
CLEAR “COMPOSITION A”

| Component | Ex. 3 |
|---|---|
| Dispersed Acrylic Polymer (Pliolite 7103 from Eliokem) | 46.52 |
| Water | 46.53 |
| Wetting agent (Tamol 165 from Rohm & Haas) | 0.50 |
| Anti-foaming agent (Foamaster NXZ from Cognis) | 0.50 |
| Hydroxyethyl cellulose (Cellosize QP-100-MH from Dow) | 1.00 |
| Silica (OK 412) | 2.50 |
| Organo functional silane (A-187) | 0.20 |
| Carbodiimide (UCARLNK XL-25-SE from Dow) | 2.00 |
| Ammonium hydroxide (28% Ammonia) | 0.25 |
| (Total Weight Percent) | (100.00) |

The “Composition A” of Example 3 is clear and its Brookfield viscosity is believed to be in the range of about 10,000 to about 20,000 cps measured at 25° C. using a No. 4 spindle operating at 20 rpm.

### EXAMPLE 4

### Preparation of “Composition B”

A “Composition B” is prepared by blending together the following components in the respective amounts indicated using a Cowles blade operating at about 1000 to about 2500 rpm in a mixer:

COMPOSITION B

| | |
|---|---|
| Water | 97.73 |
| Quaternized cellulose ether | 2.03 |
| Polyquaternium-10 (UCARE Polymer JR-30 from Dow) | |
| Bacteriocide (Nuosept 95 from Intl. Specialty Products | 0.24 |
| or Rozone 2000 from Acima, a Rohm & Haas Co.) | |
| (Total Weight Percent) | (100.00) |

The Brookfield viscosity of the resulting “Composition B” is about 50,000 cps measured at 25° C. using a No. 4 spindle operating at 20 rpm.

### EXAMPLE 5

### Preparation of “Composition C”

A “Composition C” is prepared by blending together the following components in the respective amounts indicated using a Cowles blade operating at about 750 to about 2000 rpm in a mixer:

COMPOSITION C

| | |
|---|---|
| Water | 91.99 |
| Synthetic sodium magnesium lithium | 8.01 |
| hectorite clay (Laponite RDS from Rockwood | |
| Specialties, Inc.) | |
| (Total Weight Percent) | (100.00) |

The Brookfield viscosity of the resulting “Composition C” is about 85,000 cps measured at 25° C. using a No. 4 spindle operating at 20 rpm.

### EXAMPLE 6

### Preparation of “Composition D”

A “Composition D” which is clear, pigmented, metallic or which includes a transparent dye, as desired, is prepared by blending together the following components in the respective amounts indicated using a Cowles blade operating at about 750 to about 1500 rpm in a mixer.

The same water dispersible, film-forming, cross-linkable polyurethane polymer employed in the discontinuous phase (see Composition A above) is used in preparing “Composition D” (a preference). The addition of such a polymer in a “Composition D” of a multicolor paint produces a more impregnable film with a higher solids content and better hiding properties relative to a paint which includes a “Composition D” formed with a similar, but non-carboxylated, polymer.

The use of the foregoing polymer in a “Composition D” of a multicolor paint also provides a more homogeneous paint film in a multicolor paint which improves the drying speed, the sheen control, washability, durability and water resistance of the final coating. When the foregoing polymer is coated, dried, and cross-linked, a high degree of hardness, mar resistance, chemical resistance and thermal stability is provided in the resulting coating. The resulting multicolor paint can be applied as a surface coating with a paint roller or brush and can be sprayed with spray equipment.

Components for each paint are expressed on a 100 weight percent total composition basis in Table XI (below).

TABLE XI
COMPOSITION D

| | Transparent | Pigment | Metallic | Transparent |
|---|---|---|---|---|
| | Ex. 6a | Ex. 6b | Ex. 6c | Ex. 6d |
| Carboxylated Polymer | 66.38 | 64.57 | 69.84 | 70.92 |
| (Pliolite 7103 from Eliokem) | | | | |
| Water | 7.27 | 7.09 | 7.65 | 7.74 |
| Defoamer (Foamex 805) | 0.3 | 0.29 | 0.32 | 0.33 |
| Wetting agent (Tamol 165 from | — | 0.15 | 0.16 | 0.16 |
| Rohm & Haas) | | | | |
| Silica (OK412) | 10 | 2.50 | 2.63 | 2.67 |
| Titanium dioxide (Dupont R-900) | — | 9.75 | — | — |
| Water-miscible aluminum paste | — | — | 2.63 | — |
| (StapaHydrolac W-60-NL from | | | | |
| Eckart-Werke) | | | | |
| Organ. cosol. (Butyl Cellosolve from | 11.47 | 11.18 | 12.07 | 12.21 |
| Dow) | | | | |
| Water-miscible dye | — | — | — | 1.07 |
| (NEROSOL Yellow R from Dow) | | | | |
| Monomeric plasticizer | 4.58 | 4.47 | 4.70 | 4.90 |
| (Total Weight Percent) | (100.00) | (100.00) | (100.00) | (100.00) |

The Brookfield viscosity of each resulting “Composition D” is about 1,000 to 1,500 cps measured at 25° C. using a No. 4 spindle operating at 20 rpm.

### EXAMPLE 7

### Preparation of First Disperse Phase Gel Composition

A first disperse phase gel composition is prepared by blending together the following indicated amounts of each of Examples 1 and 4 using a Cowles modified serrated blade operating at about 800 to 1500 rpm in a mixer: The mixing blade speed and the mixing duration time directly affect gel particle size.

TABLE XII

| | Ex. 7a | Ex. 7b |
|---|---|---|
| “Composition A” (Example 1 (white)) | 45.3 | — |
| “Composition A” (Example 2 (black)) | — | 45.3 |
| “Composition B” (Example 4) | 9.81 | 9.81 |
| “Composition C” (Example 5) | 44.89 | 44.89 |
| (Total Weight Percent) | (100.00) | (100.00) |

The Brookfield viscosity of the resulting gel composition is about 26,000 cps measured at 25° C. using a No. 4 spindle operating at 20 rpm.

Other colors can be formulated by using alternative pigments in Compositions A, Examples 1 and 2, and then following the procedure set forth in the preceding Examples. Thereby, an unlimited variety of disperse phase colors can be obtained, if desired.

### EXAMPLE 8

### Preparation of First Disperse Phase Gel Composition

A first disperse phase gel composition is prepared by blending together the following indicated amounts of each of Examples 1 and 5 using a Cowles blade operating at about 1000 to about 2000 rpm in a mixer:

| | |
|---|---|
| “Composition A” Example 1 (white) | 82.40 |
| “Composition C” Example 5 | 17.60 |
| (Total Weight Percent) | (100.00) |

The Brookfield viscosity of the resulting gel composition is about 31,000 cps measured at 25° C. using a No. 4 spindle operating at 20 rpm.

### EXAMPLE 9

### Preparation of First Disperse Phase Gel Composition

A first disperse phase gel composition is prepared by blending together the following indicated amounts of each of Examples 1, 4 and 5 using a Cowles blade operating at about 1000 to about 2500 rpm in a mixer:

| | |
|---|---|
| “Composition A” Example 1 (white) | 70.00 |
| “Composition B” Example 4 | 15.00 |
| “Composition C” Example 5 | 15.00 |
| (Total Weight Percent) | (100.00) |

The Brookfield viscosity of the resulting gel composition is about 35,000 cps measured at 25° C. using a No. 4 spindle operating at 20 rpm.

### EXAMPLE 10

### Preparation of Second Disperse Phase Gel Composition

A second disperse phase gel composition is prepared by blending together the following indicated amounts of each of Examples 2 and 4 using a Cowles blade operating at about 800 to 1500 rpm in a mixer:

| | |
|---|---|
| “Composition A” Example 2 (black) | 82.40 |
| “Composition B” Example 4 | 17.60 |
| (Total Weight Percent) | (100.00) |

The Brookfield viscosity of the resulting gel composition is about 29,500 cps measured at 25° C. using a No. 4 spindle operating at 20 rpm.

### EXAMPLE 11

### Preparation of Second Disperse Phase Gel Composition

A second disperse phase gel composition is prepared by blending together the following indicated amounts of each of Examples 2 and 5 using a Cowles blade operating at about 1000 to about 2000 rpm in a mixer:

| | |
|---|---|
| “Composition A” Example 2 (black) | 82.40 |
| “Composition C” Example 5 | 17.60 |
| (Total Weight Percent) | (100.00) |

The Brookfield viscosity of the resulting gel composition is about 32,000 cps measured at 25° C. using a No. 4 spindle operating at 20 rpm.

### EXAMPLE 12

### Preparation of Second Disperse Phase Gel Composition

A second disperse phase gel composition is prepared by blending together the following indicated amounts of each of Examples 2, 4 and 5 using a Cowles blade operating at about 1000 to about 2500 rpm in a mixer:

| | |
|---|---|
| “Composition A” Example 2 (black) | 70.00 |
| “Composition B” Example 4 | 15.00 |
| “Composition C” Example 5 | 15.00 |
| (Total Weight Percent) | (100.00) |

The Brookfield viscosity of the resulting gel composition is about 37,500 cps measured at 25° C. using a No. 4 spindle operating at 20 rpm.

### EXAMPLE 13

### Preparation of Third Disperse Phase Gel

A clear third disperse phase gel composition is prepared by blending together the following indicated amounts of each using a Cowles blade operating at about 1000 to about 2500 rpm in a mixer:

| | |
|---|---|
| “Composition A” Example 3 | 70.00 |
| “Composition B” Example 4 | 15.00 |
| “Composition C” Example 5 | 15.00 |
| (Total Weight Percent) | (100.00) |

The Brookfield viscosity of the resulting clear gel composition is about 35,000 cps measured at 25° C. using a No. 4 spindle operating at 20 rpm.

### EXAMPLES 14-17

### Preparation of Multicolor Paints each Including a Composition D as the Continuous Phase

Multicolor paints corresponding to each of Examples 14-17 are each prepared by mixing the respective specified quantity of Composition D shown in Table XIII with the specified quantity of each of the respective indicated quantities of the specified previously described and prepared compositions also shown in Table XIII. Components of each paint are expressed on a 100 weight percent total composition basis.

TABLE XIII

| | | | Ex. 16 | |
|---|---|---|---|---|
| | Ex. 14 | Ex. 15 | Trans- | Ex. 17 |
| | White | Black | parent | Black |
| | & | & | Yellow & | & |
| | Black | metallic | Metallic | White |
| First disperse phase gel (white) | 56.13 | | | 14.03 |
| Examples 7, 8 and 9 | | | | |
| Second disperse phase gel | 14.03 | 56.13 | | 56.13 |
| (black) | | | | |
| Examples 10, 11 and 12 | | | | |
| Third disperse phase gel (clear) | | 14.03 | 70.15 | |
| Example 13 | | | | |
| Composition D clear (Ex. 6a) | 29.84 | | | 23.00 |
| Composition D pigmented | | | | 6.85 |
| (Ex. 6b) | | | | |
| Composition D metallic (Ex. 6c) | | 29.84 | 23.00 | |
| Composition D transparent dye | | | 6.85 | |
| (Ex. 6d) | | | | |
| Total Weight Percent | 100.00 | 100.00 | 100.00 | 100.00 |

Throughout the preparation of the multicolor paints of Examples 14-17, a propeller in a mixer operates in the range of about 400 to about 500 rpm. The Brookfield viscosity of the product multicolor paint is in the range of about 5,000 to about 7,000 cps measured at 25° C. using a No. 4 spindle operating at 20 rpm.

### EXAMPLES 18-21

### Preparation of Multicolor Paint including Hydrophobic Polyisocyanate

Each of the multicolor paints of Examples 14-17 is admixed with a dissolved hydrophobic polyisocyanate using hand stirring. Alternatively, a comparable mixing method may be used. The amount and type of hydrophobic polyisocyanate, and the identity of the immiscible solvent liquid is identified in Table XIII (above).

TABLE XIV

| | | | Ex. 20 | |
|---|---|---|---|---|
| | Ex. 18 | Ex. 19 | Trans- | Ex. 21 |
| | White | Black | parent | Black |
| | & | & | Yellow & | & |
| | Black | metallic | Metallic | White |
| First disperse phase gel (white) | 49.21 | | | 12.30 |
| Examples 7, 8 and 9 | | | | |
| Second disperse phase gel | 12.30 | 49.21 | | 49.21 |
| (black) | | | | |
| Examples 10, 11 and 12 | | | | |
| Third disperse phase gel (clear) | | 12.30 | 61.51 | |
| Example 13 | | | | |
| Composition D clear (Ex. 6a) | 26.17 | | | 20.17 |
| Composition D pigmented (Ex. | | | | 6.00 |
| 6b) | | | | |
| Composition D metallic (Ex. | | 26.17 | 20.17 | |
| 6c) | | | | |
| Composition transparent dye | | | 6.00 | |
| (Ex. 6d) | | | | |
| 70% soln. HDTLV in n-butyl | 12.32 | 12.32 | 12.32 | 12.32 |
| acetate | | | | |
| Total Weight Percent | 100.00 | 100.00 | 100.00 | 100.00 |

In place of, or in combination with, HDTLV (hexane diisocyanate trimer, low viscosity), other hydrophobic polyisocyanates, such as HDT (hexane diisocyanate trimer), HDB (hexane diisocyanate biuret), Desmodur N 3600, Desmodur N 3300, IPDI (isophorone diisocyanate) and TMXDI (tetramethylxylene diisocyanate), and like hydrophobic polyisocyanates can also be used in combination, or as a sole replacement, with n-butyl acetate, or propyl methoxy acetate, among others as a solvent carrier.

In a product, the actual solids can be varied, if desired, depending upon particular application requirements. The Brookfield viscosity of the product multicolor paint is typically in the range of about 5,000 to about 7,000 cps measured at 25° C. using a No. 4 spindle operating at 20 rpm.

Mixing is conveniently carried out as indicated in Examples 14-17 (above).

The foregoing multicolor paints exhibit the improved properties discussed above. The paint can be applied as a surface coating with a paint roller or brush, or the like, and can be sprayed with spray equipment as described below.

### EXAMPLES 22-30

### Application of the Multicolor Paint

Each of the multicolor paints of the Examples 14-17 and of the Examples 18-21 is applied to a different respective wood panel or Alodine 5700 treated aluminum panels using each of:

(1) roller application using a foam roller having 30-60 pps (pores per square inch);

(2) brush application using a foam, synthetic and/or bristle type brush;

(3) application with a conventional air spray apparatus with a pressurized feed tank and dual regulators. (A Binks Gun Model 2001 with either an internal or external mix air nozzle assembly. Air pressures with an internal mix assembly: gun pressure are about 30 psi with material air pressure is about 35 psi. Air pressures with an external mix nozzle assembly are about 20 to 30 psi with a material air pressure of about 10 to 15 psi.)

(4) application with an airless sprayer. (A pump type Graco Model PT2500 with 221-517 tip size using application pressures of about 200 psi at the gun tip.)

(5) application with a H.V.L.P. sprayer (high volume, low pressure). (A Wagner Cap Spray Unit CS5000 or CS8000).

It is found that a uniform multicolor coating is produced from each paint. Each coating dries to a tack-free film (or coating) in about 60 minutes in ambient air. If desired, drying time of a coated paint can be accelerated by forced air drying at 125-250° F. Maximum film properties are attainable after an additional post-curing time of 2 days in ambient air.

Prior to the presently considered testing, each panel is either aged for 7 days at room temperature, or is forced dried at 120 degrees F overnight.

Each fully cured coating is found to pass the ASTM No. D-1308-79 water spot test, both opened and covered, and the ASTM No. D-1308 organic solvent tests both opened and covered.

As the exemplary results for the coatings derived from the multicolor paints Examples 14 and 18 show, as summarized in Table XV (below), each of the coatings is applied over Alodine 5700 treated aluminum panel and is evaluated for a water spot test and an aluminum adhesion test. In the water test, water is dropped onto each film and the resulting treated film is checked for film integrity using coin scratching. (No watch glass procedure is used.)

The coatings of Examples 18-21 are found to have superior water and organic solvent resistance compared to the coatings of Examples of 14-17.

TABLE XV

| | Water | | | Hydraulic | Aluminum |
|---|---|---|---|---|---|
| Test Results | Spot* | MEK Rubs | Gasohol | Fluid | adhesion |
| Example 14: | <30 | Dissolves | Dissolves | Dissolves | Pulls off |
| Control | minutes | | | | |
| Example 18: | No | 20 + Double | No effect | No effect | Excellent |
| component | effect | rubs/slight | | | |
| mix | mar | | | | |

### EXAMPLES 31 Through 50

### Other Embodiments

Further embodiments of multicolor paints of the invention are provided.

Examples of Compositions A are provided in Examples 31 through 40 as summarized in Table XVI below. These Compositions A are each prepared by using the procedure above described in Examples 1 and 2. Using the procedure and quantities of Example 7a (above), each Composition A is mixed with Composition B (prepared as in Example 4 (above)) and Composition C (prepared as in Example 5 (above)) to produce a disperse phase composition. Each disperse phase composition is blended with a 70% solution of HDTLV in n-butyl acetate at the rate of 14 grams of such solution per 100 grams of disperse phase composition.

Examples of Compositions D are provided in Examples 33 through 42 as summarized in Table XVII below. These Compositions D are each prepared by using the procedure above described in Examples 6. Each Composition D is blended with a 70% solution of HDTLV in n-butyl acetate at the rate of 14 grams of such solution per 100 grams of Composition D.

Each such Composition D is blendable with each such disperse phase composition in a 1:1 weight ratio or in another amount as taught herein to produce, a multicolor paint of the invention. When each such multicolor paint is applied as a coating and dried, the product coating has a clear matrix with white spots.

The product coatings show improved water and organic solvent resistance results compared to coatings from corresponding multicolor paints that do not contain hydrophobic polyisocyanate.

If desired, additional hydrophobic polyisocyanate can be added to a multicolor paint made with such a Composition A and/or such a Composition D.

TABLE XVI
Other Embodiments of “Composition A”

| | Ex. 31 | Ex. 32 | Ex. 33 | Ex. 34 | Ex. 35 | Ex. 36 | Ex. 37 | Ex. 38 | Ex. 39 | Ex. 40 |
|---|---|---|---|---|---|---|---|---|---|---|
| Component | Wt % | Wt % | Wt % | Wt % | Wt % | Wt % | Wt % | Wt % | Wt % | Wt % |
| Polymer Solution | | | | | | | | | | |
| Hydreau AR 110 | 32.47 | | | | | | | | | |
| Aquamac 260 | | 29.5 | | | | | | | | |
| Hydreau AR 190 | | | 30.06 | | | | | | | |
| Aquamac 588 | | | | 29.5 | | | | | | |
| Arolon 860-W-45 | | | | | 36.07 | | | | | |
| Synthemul 40-423 | | | | | | 33.12 | | | | |
| Resyn 7448 | | | | | | | 29.5 | | | |
| Joncryl 2561 | | | | | | | | 33.46 | | |
| Joncryl 538 | | | | | | | | | 36.07 | |
| Joncryl 1972 | | | | | | | | | | 40.58 |
| Water | 38.22 | 41.19 | 40.63 | 41.49 | 34.62 | 37.57 | 41.19 | 37.23 | 34.62 | 30.11 |
| Wetting Agent (Tamol 165) | 0.51 | 0.51 | 0.51 | 0.51 | 0.51 | 0.51 | 0.51 | 0.51 | 0.51 | 0.51 |
| Defoamer (Foamaster NXZ) | 0.2 | 0.2 | 0.2 | 0.2 | 0.2 | 0.2 | 0.2 | 0.2 | 0.2 | 0.2 |
| Hydroxyethyl cellulose | 0.71 | 0.71 | 0.71 | 0.71 | 0.71 | 0.71 | 0.71 | 0.71 | 0.71 | 0.71 |
| (Natrosol) | | | | | | | | | | |
| Titanium dioxide (Dupont R900) | 19.73 | 19.73 | 19.73 | 19.73 | 19.73 | 19.73 | 19.73 | 19.73 | 19.73 | 19.73 |
| Black iron oxide (Bayferrox 316) | — | — | — | — | — | — | — | — | — | — |
| Barium sufate (Barytes) | — | — | — | — | — | — | — | — | — | — |
| Organofunctional silane (A-187) | 0.2 | 0.2 | 0.2 | 0.2 | 0.2 | 0.2 | 0.2 | 0.2 | 0.2 | 0.2 |
| Ammonia | 0.25 | 0.25 | 0.25 | 0.25 | 0.25 | 0.25 | 0.25 | 0.25 | 0.25 | 0.25 |
| Bacteriocide | 0.2 | 0.2 | 0.2 | 0.2 | 0.2 | 0.2 | 0.2 | 0.2 | 0.2 | 0.2 |
| Polyethylene wax | 1 | 1 | 1 | 1 | 1 | 1 | 1 | 1 | 1 | 1 |
| Monomeric plasticizer | 1.72 | 1.72 | 1.72 | 1.72 | 1.72 | 1.72 | 1.72 | 1.72 | 1.72 | 1.72 |
| Organic cosolvents | 4.76 | 4.76 | 4.76 | 4.76 | 4.76 | 4.76 | 4.76 | 4.76 | 4.76 | 4.76 |
| Total weight | 100 | 100 | 100 | 100 | 100 | 100 | 100 | 100 | 100 | 100 |

TABLE XVII
Other Embodiments of “Composition D”

| | Ex. 41 | Ex. 42 | Ex. 43 | Ex. 44 | Ex. 45 | Ex. 46 | Ex. 47 | Ex. 48 | Ex. 49 | Ex. 50 |
|---|---|---|---|---|---|---|---|---|---|---|
| Component | Wt % | Wt % | Wt % | Wt % | Wt % | Wt % | Wt % | Wt % | Wt % | Wt % |
| Polymer Solution | | | | | | | | | | |
| Hydreau AR 110 | 59.74 | | | | | | | | | |
| Aquamac 260 | | 54.31 | | | | | | | | |
| Hydreau AR 190 | | | 55.32 | | | | | | | |
| Aquamac 588 | | | | 54.31 | | | | | | |
| Arolon 860-W-45 | | | | | 66.38 | | | | | |
| Synthemul 40-423 | | | | | | 60.96 | | | | |
| Resyn 7448 | | | | | | | 54.31 | | | |
| Joncryl 2561 | | | | | | | | 61.59 | | |
| Joncryl 538 | | | | | | | | | 66.38 | |
| Joncryl 1972 | | | | | | | | | | 74.68 |
| Water | 13.91 | 19.34 | 18.34 | 19.34 | 7.27 | 12.69 | 19.34 | 12.06 | 7.27 | 0 |
| Defoamer (Foamex 805) | 0.3 | 0.3 | 0.3 | 0.3 | 0.3 | 0.3 | 0.3 | 0.3 | 0.3 | 0.3 |
| Silica (OK 412) | 10 | 10 | 10 | 10 | 10 | 10 | 10 | 10 | 10 | 10 |
| Organic cosolvent | 11.47 | 11.47 | 11.47 | 11.47 | 11.47 | 11.47 | 11.47 | 11.47 | 11.47 | 10.44 |
| (Butyl Cellosolve) | | | | | | | | | | |
| Monomeric plasticizer | 4.58 | 4.58 | 4.58 | 4.58 | 4.58 | 4.58 | 4.58 | 4.58 | 4.58 | 4.58 |
| (Butyl benzyl phthalate) | | | | | | | | | | |
| Total Weight | 100 | 100 | 100 | 100 | 100 | 100 | 100 | 100 | 100 | 100 |

In Tables XVI and XVII (above):

“Hydreau” is a trademark of Eastman Chemical Company for a waterborne thermoplastic acrylic latex polymer.

“Aquamac” is a trademark of Eastman Chemical Company for a brand of polyvinylacetate copolymer latex emulsion.

“Arolon” is a trademark of Reichhold, Inc. for a brand of liquid copolymer vehicle based on styrenated acrylic polymers.

“Synthemul” is a trademark of Reichhold, Inc. for a brand of emulsifiable synthetic resin comprising a fine particle size acrylic latex.

“Resyn” is a trademark of National Starch and Chemical Investment Holding Corporation for a brand of synthetic resin adhesive comprising a small particle size vinyl-acrylic emulsion.

“Joncryl” is a trademark of S.C. Johnson Commercial Markets, Inc. for acrylic polymers and acrylic resins.

“Tamol” is a trademark of Rohm and Haas Company for a dispersing agent that comprises a salt of a polycarboxylic acid.

“Natrosol” is a trademark of Hercules, Incorporated for a brand of water-soluble hydroxyethyl cellulose.

“Bayferrox” is a trademark of Bayer Aktiengesellschaft Corporation for a brand of iron oxide pigment.

In the foregoing Examples, the hydroxyethyl cellulose can be replaced with: A) hydroxymethyl cellulose (Dow A type); B) hydroxypropyl cellulose (Aqualon Klucel S-97A type); and C) sodium carboxy methyl cellulose (Aqualon CMC-7-7H3SF). The carbodiimide cross-linker can be replaced by the polyfunctional aziridine cross-linking agent “Zama-7” from Virginia Chemicals. The “Composition C” hectorite clay (Laponite RDS) can be replaced by: A) Laponite RD; B) Veegum T; and C) Macaloid. And the “Composition C” peptizing agent (tetrasodium pyrophosphate) can be replaced by: A) sodium pyrophosphate; B) sodium tripolyphosphate; and C) sodium hexametaphosphate.

While the foregoing description makes use of illustrative examples of various types, no limitations upon the present invention are to be implied or inferred therefrom.

What is claimed is:

1. A method for making a water-in-water multicolor paint comprising the steps of:
(A) providing a first composition comprising on a 100 weight percent first composition basis:
(a) about 10 to about 40 weight percent of an inert film-forming, water-dispersed, cross-linkable carboxylated polymer system,
(b) from and including 0 to about 10 weight percent of cross-linking material selected from the group consisting of reactive curatives and organic cross-linking agents;
(c) about 0.5 to about 2 weight percent dissolved cellulose material selected from the class consisting of hydroxy (lower alkyl) cellulose and alkali metal carboxylated (lower alkyl) cellulose;
(d) from and including 0 to about 35 weight percent of hydrophobic polyisocyanate;
(e) from and including 0 to about 10 weight percent of film-forming, water dispersed, cross-linkable pressure responsive adhesive;
(f) from and including 0 to about 10 weight percent of waterborne polyol;
(g) from and including 0 to about 40 weight percent dispersed pigment;
(h) from and including 0 to about 15 weight percent organic cosolvent;
(i) from and including 0 to about 30 weight percent of water immiscible organic liquid which is a solvent for said hydrophobic polyisocyanate; and
(j) about 20 to about 80 weight percent water; the relationship between components of said first composition being such that said first composition has a viscosity in the range of about 10,000 to 30,000 centipoises measured with a Brookfield viscometer operating at 20 rpm at 25° C. with a No. 4 spindle;
(B) providing a second composition comprising on a 100 weight percent second composition basis:
(a) about 0.5 to about 5 weight percent dissolved cationic quaternized cellulose ether; and
(b) about 55 to about 99.5 weight percent water; providing a third composition comprising on a 100 weight percent third composition basis:
(C) providing a third composition comprising on a 100 weight percent total third composition basis:
(a) about 5 to about 10 weight percent dispersed water swellable clay;
(b) about 0.5 to about 2 weight percent dissolved peptizing agent; and
(c) about 88 to about 95 weight percent water;
(D) providing a fourth composition comprising on a 100 weight percent fourth composition basis:
(a) about 0.5 to about 40 weight percent of said inert film forming, water dispersed, cross-linkable, polymer system;
(b) from and including 0 to about 5 weight percent of said cross-linking material;
(c) from and including 0 to about 25 weight percent of said hydrophobic polyisocyanate;
(d) from and including 0 to about 30 weight percent of said pressure responsive adhesive;
(e) from and including 0 to about 40 weight percent of said waterborne polyol;
(f) about 1.5 to about 5 weight percent of water dispersed, water swellable clay,
(g) about 0.1 to about 0.8 weight percent of dissolved peptizing agent,
(h) from and including 0 to about 30 weight percent of pigment,
(i) from and including 0 to about 0.25 weight percent of anti-foaming agent,
(j) from and including 0 to about 0.25 weight percent of wetting agent,
(k) from and including 0 to about 0.25 weight percent of organo functional silane,
(l) from and including 0 to about 5 weight percent of colloidal silica,
(m) from and including 0 to about 15 weight percent of organic cosolvent,
(n) from and including 0 to about 30 weight percent of water immiscible organic liquid which is a solvent for said hydrophobic polyisocyanate;
(o) about 30 to about 70 weight percent water, the relationship between components of said fourth composition being such that said fourth composition has a viscosity in the range of about 500 to about 5,000 centipoises measured with a Brookfield viscometer operating at 20 rpm at 25° C. with a No. 4 spindle;
(E) blending said first composition with a composition selected from the group consisting of:
(a) said second composition in the weight ratio range of about 85:15 through about 80:20 of said first composition to said second composition;
(b) said third composition in the weight ratio range of about 85:15 to about 80:20 of said first composition to said third composition, and
(c) a combination of said second composition and said third composition in the weight ratio range of about 70:15:15 to about 80:10:10 of said first composition to said second composition to said third composition so as to produce a first disperse phase gel composition having a viscosity in the range of about 25,000 to about 85,000 centipoises measured with a Brookfield viscometer operating at 20 rpm at 25° C. with a No. 4 spindle; and
(F) mixing said first disperse phase gel composition with said fourth composition said mixing being carried out in the presence of said hydrophobic polyisocyanate, the total amount of said hydrophobic polyisocyanate present based on 100 weight percent total of all components present during said mixing being in the range from greater than 0 to about 40 weight percent, the respective amounts of said first disperse phase gel composition and of said fourth composition being such that the ratio of the viscosity of said fourth composition to the viscosity of said first disperse phase composition is in the range of about 1:5 to about 1:10, the mixing shear force used in said mixing being sufficient to (a) break up said first disperse phase gel composition into discrete gel bodies dispersed in said fourth composition, and (b) disperse said hydrophobic polyisocyanate, said mixing shear force being inversely proportional to the average size of said so formed disperse phase bodies, thereby to produce said multicolor paint.

2. The method of claim 1 wherein said hydrophobic polyisocyanate is initially dissolved in said water immiscible organic liquid and wherein the total amount of hydrophobic isocyanate ranges from about 1 to about 40 weight percent on a 100 weight percent total multicolor paint composition product basis.

3. The method of claim 2 wherein at least a portion of said hydrophobic polyisocyanate is initially added to at least one of said first composition in step (A) and said fourth composition in step (D).

4. The method of claim 2 wherein at least a portion of said hydrophobic polyisocyanate is added during said mixing of step (F).

5. The method of claim 2 wherein at least most of said hydrophobic polyisocyanate is added during said mixing of step (F).

6. The method of claim 2 wherein in step (F) at least a portion of said hydrophobic polyisocyanate is added to a resulting mixture produced by first admixing said first disperse phase gel composition with said fourth composition in the ratio range indicated and with the mixing shear force indicated in said step (F).

7. The method of claim 1 wherein said pressure responsive adhesive is not present.

8. The method of claim 1 wherein said pressure responsive adhesive is initially added to at least one of said first composition in step (a) and said fourth composition in step (D).

9. The method of claim 2 wherein at least some of said pressure responsive adhesive is added during said mixing of step (F).

10. The method of claim 2 wherein all of said pressure responsive adhesive is added during said mixing of step (F).

11. The method of claim 1 wherein said water-dispersed, inert-film forming, cross-linkable polymer system comprises a carboxylated polymer system which:
(a) is substantially free from urethane linkages and urea linkages and also is substantially free from functional groups selected from the class consisting of hydroxyl, amino, and isocyanato, and
(b) contains at least sufficient water-dispersed cross-linking agent selected from the group consisting of multifunctional carbodiimides and polyfunctional aziridines to cross-link said carboxylated polymer when said carboxylated polymer and said cross-linking agent are dried from an aqueous dispersion at room temperatures.

12. The method of claim 1 wherein in said first composition is comprised of said carboxylated polymer system.

13. The method of claim 1 wherein in said fourth composition is comprised of said carboxylated polymer system.

14. The method of claim 1 wherein said cellulose material is hydroxy (lower alkyl) cellulose, said water swellable clay is a synthetic sodium magnesium lithium hectorite clay, and said peptizing agent is tetrasodium pyrophosphate.

15. The method of claim 1 wherein said step (E) is repeated a plurality of times, and each one of the resulting so produced plurality of disperse phase gel compositions has a different color relation to others thereof, and each one of said resulting disperse phase gel compositions is so mixed with said fourth composition in a step (F).

16. The method of claim 1 wherein the weight ratio of the total weight of said disperse phase gel compositions to the weight of said fourth composition is in the range of about 1:1 to about 6:4.

17. The method of claim 1 wherein each of said disperse phase gel compositions has a viscosity which is about 7 to about 8.5 times greater than the viscosity of said fourth composition.

18. The method of claim 1 where, in said step (E), said first composition is so blended with said combination of said second composition and said third composition to produce said first disperse phase gel composition.

19. The method of claim 1 wherein a second disperse phase gel composition is prepared by said steps (A) through (C) and (E), said second disperse phase composition contains a pigment which results in a different coloration for said second disperse phase gel composition relative to said first disperse phase gel composition, and said second disperse phase composition is likewise additionally mixed with said fourth composition as prepared by said step (D) and broken up into discrete gel bodies using a mixing procedure as described in said step (F), thereby to produce a multicolor water-in-water paint.

20. The method of claim 19 wherein a plurality of further disperse phase gel compositions are prepared each by said steps (A) through (C) and (E), each of said further disperse phase gel compositions contains a pigment which is different from all others of said disperse phase gel compositions, and each of said further disperse phase compositions is mixed with said fourth composition and broken up into discrete gel bodies using a mixing procedure as described in said step (F), thereby to produce a multicolor water-in-water paint.

21. A water-in-water multicolor paint produced by the method of claim 1.

22. A water-in-water multicolor paint comprising a discontinuous aqueous phase dispersed in a continuous aqueous phase, said discontinuous aqueous phase being comprised of a plurality of discrete gel bodies, such gel bodies being comprised of a uniform aqueous composition containing in admixture:
water dispersed, film-forming, cross-linkable carboxylated polymer system comprising on a 100 weight percent total polymer solids basis about 75 to and including 100 weight percent of polyurethane polymer and correspondingly from and including 0 up to about 25 weight percent of reactive curative, and said carboxylated polymer system comprising on a 100 weight percent total polymer solids basis about 75 to and including 100 weight percent carboxylated polymer and correspondingly from and including 0 up to about 25 weight percent of organic cross-linking agent;
cellulose material selected from the class consisting of hydroxy (lower alkyl) cellulose and alkali metal carboxylated (lower alkyl) cellulose; and
at least one gel former selected from the class consisting of quaternized ethyl cellulose, and incorporating a preformed gel comprised of water swellable clay, peptizing agent and water;
said continuous aqueous phase comprising a preformed gel comprised of said water dispersed, film-forming, cross-linkable polymer system, said water swellable clay, said peptizing agent and water, the viscosity of said continuous phase being less than the viscosity of said discontinuous phase, said water dispersed, film-forming, cross-linkable polymer system comprising in said continuous aqueous phase on a 100 weight percent total polymer solids basis about 75 to and including 100 weight percent of said polyurethane polymer system and correspondingly from and including 0 up to about 25 weight percent of said carboxylated polymer system;
said multicolor paint having been prepared by the method of claim 1.

23. The multicolor paint of claim 22 wherein in said water dispersed film-forming, cross-linkable polymer system said carboxylated polymer system when present:
(a) is substantially free from urethane linkages and urea linkages and also is substantially free from functional groups selected from the class consisting of hydroxyl, amino, and isocyanato; and
(b) contains sufficient water dispersed cross-linking agent selected from the group consisting of multifunctional carbodiimides and polyfunctional aziridines to cross-link said carboxylated polymer when said carboxylated polymer and said cross-linking agent are dried from an aqueous dispersion at room temperatures.

24. The multicolor paint of claim 22 wherein, in said discontinuous phase, said polymer system is comprised of said carboxylated polymer system.

25. The multicolor paint of claim 22 wherein said cellulose material is hydroxy (lower alkyl) cellulose, said water swellable clay is a synthetic sodium magnesium lithium hectorite clay, and said peptizing agent is tetrasodium pyrophosphate.

26. The multicolor paint of claim 22 wherein said discontinuous phase is comprised of at least two different classes of discrete gel bodies which respective classes differ from each other in color.

27. The multicolor paint of claim 22 wherein the weight ratio of said discontinuous aqueous phase to said continuous aqueous phase is in the range of about 1:1 to about 6:4.

28. The multicolor paint of claim 22 wherein said discontinuous aqueous phase has an average viscosity which is about 7 to about 8.5 times greater than the viscosity of said continuous aqueous phase.

29. A coating produced by applying a continuous layer of a multicolor paint of claim 22 to a surface and then drying said so applied layer.

30. The method of claim 1 wherein said first composition additionally contains
(k) from and including 0 to about 3 weight percent of a monomeric plasticizer;
(l) from and including 0 to about 0.5 weight percent of a bonding agent;
(k) from and including 0 to about 0.5 weight percent of an anti-foaming agent; and
(m) from and including 0 to about 1.0 weight percent of a wetting agent.

31. A water-in-water multicolor paint produced by the method of claim 30.

32. The method of claim 1 wherein a waterborne polyol is additionally present in at least one of said first composition, said fourth composition and said multicolor paint.

33. A multicolor paint produced by the method of claim 32.
